(19) United States
(12) Patent Application Publication
(10) Pub. No.: US 2015/0178673 A1
(43) Pub. Date: Jun. 25, 2015

(54) INVENTORY MONITORING SYSTEM AND METHOD

(71) Applicant: FULFIL-IT, Belsele (BE)

(72) Inventor: Thomas Penneman, Belsele (BE)

(21) Appl. No.: 14/409,010

(22) PCT Filed: Jun. 28, 2013
(86) PCT No.: PCT/EP2013/063748

§ 371 Date: Dec. 18, 2014

(30) Foreign Application Priority Data
Jun. 28, 2012 (GB) 1211517.6
Jan. 29, 2013 (GB) 1301592.0

(51) Int. Cl. G06Q 10/08; B61K 1/00

(52) U.S. Cl. CPC G06Q 10/087; B61K 1/00; Y10S 901/09

(57) ABSTRACT

An inventory monitoring system and method for monitoring items stored in a pallet rack are described. The inventory monitoring system comprises a pallet rack comprising a plurality of construction elements for storing a plurality of pallets and a rail system mounted to the pallet rack and forming at least one track for guiding at least one vehicle for scanning the pallets, the rail system being located at least partly inside a space defined by outer construction elements. The at least one vehicle thereby is movably mountable to the rail system and adapted for moving over the rail system, the vehicle comprising detection means for detecting information of the pallets which are located in the vicinity of the rail system.

### FIELD OF THE INVENTION

The invention relates to an inventory monitoring system and a method for monitoring items such as pallets stored in a pallet rack. The invention relates also to an inventory system and a method for automated stock-taking of items stored in a pallet-rack. The invention also relates to a method for upgrading an existing pallet rack.

### BACKGROUND OF THE INVENTION

The monitoring, counting and recording of individual items in logistics, industrial, commercial and administrative environments is labor intensive, expensive and error prone. The introduction of barcode scanning and the use of automated warehouses was an initial response to this problem. The development and use of Radio Frequency Identification (RFID) tags is a further development, and has proven to be very effective for tracking and controlling movements of goods, e.g. shipments from suppliers to the warehouse, or from the warehouse to the end customer. However, the making of an inventory or checking the stock lying in a warehouses, although improved by using barcodes or RFID-tags, remains a time consuming task that is error-prone.

There exist solutions, known as “smart shelves”, where the antenna's (and readers) are integrated in the shelve or rack, but these solutions are extremely expensive if used in palletracks. This because you need approximately 5000 antenna's and 160 readers for a 10.000 pallet-location rack. Another problem of such a system with multiple integrated antenna's and readers is that the antenna's and the readers may disturb each other (simultaneous communications), and the risk of failure is increased, as is the maintenance cost.

It is also known to use RFID-readers at the front of a forklift, so that a pallet is scanned when it is e.g. unloaded from a truck and stored into a pallet-rack, or vice versa. Such systems however only register pallet movements, and are normally not suited for taking stock.

There are also solutions known where a construction is placed in front of a pallet-rack, and where a reader, e.g. a barcode reader is moved in height and width directions before the rack, for scanning the pallets in the rack. A disadvantage of such systems is that it hinders normal loading/unloading operations, and it does not work for pallet-racks that are more than one or two pallets deep.

There is a need for a more efficient inventory system for stock-taking, whereby normal warehouse operations, i.e. loading and unloading of pallets, are not disturbed, but that is less expensive than the above mentioned “smart shelves”.

### SUMMARY OF THE INVENTION

It is an object of embodiment of the present invention to provide an inventory monitoring system for monitoring items stored in a pallet rack that is more effective and less error prone, as well as a method for using it and a method for upgrading existing pallet racks for allowing automatic stock taking using such a method.

It is an advantage of embodiments of the present invention, that automated stock-taking of items stored in an pallet-rack can be made more effective and less error prone.

It is an advantage of embodiments of the present invention that these systems and methods provide inventory monitoring systems for monitoring and/or automated stock-taking of items stored in a pallet-rack, that offer any or all of the following advantages: the system requires a lower installation and maintenance cost, the stock-taking is safer, less labor-intensive, and does not disturb the storing/removing of items in/from the pallet-rack, so it can be performed simultaneously with loading/unloading of pallets into/from the pallet-rack.

The above objective is accomplished by a method and system according to the present invention.

In a first aspect of the present invention, an inventory monitoring system is provided for monitoring items stored in a pallet rack, the inventory monitoring system comprising: the pallet rack comprising a plurality of construction elements for storing a plurality of pallets, a rail system mounted to the pallet rack and forming at least one track for guiding at least one vehicle for scanning the pallets, the rail system being located at least partly inside a space defined by outer construction elements and at least one vehicle being movably mountable to the rail system and adapted for moving over the rail system, the vehicle comprising detection means for detecting information of the pallets which are located in the vicinity of the rail system. It is an advantage of embodiments of the present invention that the monitoring, e.g. scanning and registration of pallets (or pallet items) can occur in a highly reliable way, because the detection means can be moved nearby each pallet, even if the pallet rack has e.g. 10×10×10=1,000pallet locations, whereas existing scanning systems for pallet-racks are located in front of, or on the side of the pallet rack, and are thus limited in scanning pallets that are located further away.

It is an advantage of such rail systems that it allows a single detection means, e.g. an RFID-reader, barcode scanner or other sensor, or a small number of readers, e.g. one per “level”, to be used for scanning the pallets, whereas existing systems require a huge number of readers for reliably scanning all pallets in the rack, e.g. one reader for every two to four pallet locations.

It is an advantage of an inventory monitoring system of the present invention that it does not require a scanning structure located in front of, in the back of, or next to the pallet-rack, such system usually extending over the entire height and width of the rack, and thus occupying valuable storage space, and forming obstructions to people and forklifts moving on passageways between the racks.

In embodiments of the inventory monitoring system of the present invention, the rail system is at least partly positioned in one or more dead zones of the pallet rack defined by one or more of the construction elements.

It is an advantage of such positioning that it does not or less disturb normal warehouse operations, i.e. adding/removing pallets in/from the rack, whereas in existing systems the scanning and the normal operations cannot be performed simultaneously, or when performed simultaneously result in false readings because the reader is located too far away from the goods.

It is a further advantage of such positioning that the risk of accidental damage to the inventory system is eliminated or at least drastically reduced, since under normal conditions a pallet will not be positioned in the dead zones.

It is a further advantage of such positioning that it does not occupy valuable warehouse space.

In embodiments of the inventory monitoring system of the present invention, the construction elements comprise a plurality of substantially vertical posts and a plurality of substantially lying beams, and the rail system is at least partly located inside the space defined by the posts and/or the beams

It is an advantage of embodiments of the present invention that the rail system and optionally also the vehicle travelling along that rail system is protected by the posts and/or the beams, resulting in a reduced risk of being damaged by moving goods (such as pallets) or working machinery (such as forklifts) during loading and/or unloading of items in/from the pallet rack.

In embodiments of the inventory monitoring system of the present invention, the rail system comprises a track extending at least in a horizontal and a vertical direction with respect to the pallet rack, and the vehicle is adapted for ascending and descending the track.

It is an advantage of such a rail system and vehicle that it enables scanning and monitoring of items in a pallet rack of any dimensions (width, height, depth).

In embodiments of the inventory monitoring system of the present invention, the pallet-rack comprises a plurality of substantially lying beams for supporting the pallets, and the rail-system is located at least partly in at least one substantially horizontal plane defined by corresponding lying beams.

With “substantially horizontal plane” is meant the spatial area located between two substantially horizontal planes tangent to the top and bottom side of lying beams at the same pallet level. This may e.g. be a space of about 20 cm high. While the correct geometrical terminology for this space is a “parallelepiped”, the term “substantially horizontal plane” is used in this description to indicate such space. The vehicle on the rail system can then move in the substantially horizontal plane above or below the pallets which need to be scanned/monitored. Such embodiments of the inventory monitoring system are e.g. ideally suited for the kind of pallet racks having beams oriented substantially perpendicular to the loading/unloading direction. The lying beams corresponding to a single “storage level” of the pallet rack are typically oriented horizontally, and lying on the same height, except for a small inclination angle, e.g. less than 20°, in so called “push-back pallet systems”.

It is an advantage for pallet racks having “substantially horizontal dead zones” to locate the rail system and the vehicle in this space because the beams offer excellent protection against accidental damage.

It is a further advantage of a rail system being at least partly located in a substantially horizontal plane, because movement of the vehicle in such a plane requires less energy as compared to a system where the vehicle has to change height.

In embodiments of the inventory monitoring system of the present invention, the rail system comprises a plurality of individual tracks, each located in the at least one substantially horizontal plane, and each comprising at least one vehicle.

In this embodiment each track typically covers one level of the pallet rack, and has its own vehicle. The track may have a serpentine-shape (e.g. without track-switches), or may be comb-like shaped (e.g. with track-switches).

In embodiments of the inventory monitoring system of the present invention, the rail system comprises a single three-dimensional track extending over the plurality of substantially horizontal planes, whereby track partitions located in different substantially horizontal planes are interconnected by upright track portions, the latter for example being located on one or both sides of the pallet rack.

In such embodiments, the vehicle can thus move from one level of the rack to another such that the number of vehicles required can be reduced, while still being able to reach and detect all items/pallets/goods in the pallet rack. The latter results in a reduction of the overall cost of the monitoring system, both in initial cost as in maintenance cost. Indeed, compared to existing automatic systems with a plurality of RF-scanners, there is a substantial reduction of installation cost and maintenance cost. For example, in a pallet-rack with 10×10×10=1,000 pallet-locations, a 2D-rail system would require only 10 readers (with 1 or 2 antennas each, in case of RF-readers), and a 3D-rail system would require only a single reader (with 1 or 2 antennas in case of an RF-reader), whereas existing systems typically require minimum 16 readers connected over 64 antenna hubs to about 500 stationary antennas. Furthermore, due to the fact that less readers are used, the problem of interference, i.e. disturbing neighboring readers is significantly reduced, which may reduce the number of false readings.

Furthermore it is an advantage that only one or a few vehicles need to be controlled and driven, instead of controlling a large number of readers and antenna hubs (e.g. 16+64 in the example above).

It is an advantage that a single vehicle may suffice to scan all the pallets in a rack, not only for cost and maintenance reasons, but also because the vehicle may be the only moving part of the system, which improves the system reliability.

Although a single vehicle may suffice to scan all the pallets in a rack, the number of vehicles on the track may be increased, for redundancy reasons, or so that a plurality of vehicles can detect the pallets simultaneously. The skilled person can easily determine a suitable number of vehicles for scanning all the items in a rack within a given time.

By providing a vehicle that can move over the rail system, the monitoring system allows automatic stock-taking This is less labor-intensive than manual stock-taking, and errors are avoided. In addition, pallets need not be taken out of the rack, nor need people climb the rack in order to scan or monitor stored items.

In embodiments of the inventory monitoring system of the present invention, the pallet-rack comprises a plurality of substantially vertical posts, and the rail system is located at least partly in at least one substantially vertical plane parallel to corresponding posts.

This embodiment is e.g. ideally suited for so called “drive-in” or “drive-through” pallet racks, having configurations that allow the forklift to drive directly into the lane of stacked rows (also known as “bays”). While still substantially lying horizontal, the beams are now oriented in the depth direction of the pallet rack, parallel to the loading/unloading direction, and sets of beams which are located on top of each other form substantially vertical planes separating the “lanes” by substantially vertical “dead zones”. While the correct geometrical terminology for the shape of such a “dead zone” is a “beam”, the term “substantially vertical plane” is used in this description to indicate such space. The vehicle on such a rail system can then move in the substantially vertical plane next to, e.g. on the left or on the right of the pallets which need to be scanned.

It is an advantage for pallet racks having “substantially vertical dead zones” to locate the rail system and the vehicle in this space because the beams and posts offer excellent protection against accidental damage.

In embodiments of the inventory monitoring system of the present invention, the rail system comprise a plurality of individual tracks, each located in the at least one substantially vertical plane, and each comprising at least one vehicle.

In this embodiment each track typically covers one lane of the pallet rack. The track may have a serpentine-shape (e.g. without track-switches), or may be comb-like shaped (e.g. with track-switches). In this embodiment the rail-system may have as many individual tracks as there are lanes in the pallet-rack, and each individual plane may have its own vehicle.

In embodiments of the inventory monitoring system of the present invention, the rail system comprises a single three-dimensional track extending over the plurality of substantially vertical planes, whereby track partitions located in different substantially vertical planes are interconnected by lying track portions, the latter for example being located on top of the pallet rack. A monitoring system with such a 3D-rail system has the same advantages as the 3D-system extending over the substantially horizontal planes, including reduced installation cost and maintenance cost, a single vehicle may suffice, and the possibility for automatic stock taking

In embodiments of the inventory monitoring system of the present invention, the rail system comprises primarily upright track portions, the upright track portions being located in a substantially vertical plane defined by corresponding upright posts, e.g. between adjacent upright posts.

In this embodiment the space formed by the width (e.g. 20 cm) and height of the upright posts is used as the “dead zone”, which is a smaller space than the space between the planes formed by the beams located on top of each other, and mounted on opposite sides to these posts. This offers the advantage that the rail system is even better protected against accidental collisions.

In embodiments of the inventory monitoring system of the present invention, at least 50%, advantageously at least 65%, more advantageously at least 80% of the length of the rail system is located inside the dead zones defined by the construction elements.

It is an advantage of embodiments of the present invention that the rail system can be largely (i.e. mainly) integrated in non-used spacings in the pallet rack. In some embodiments, the rail system may extend slightly outside the construction elements, e.g. for travelling to a further pallet rack, or at positions where curvature of the rail occurs, e.g. to change levels. The extension may be as small as possible (e.g. less than 10 cm) to prevent hindering passage between pallet racks, e.g. in the passageways for forklifts.

In embodiments of the inventory monitoring system of the present invention, the monitoring system further comprises location-indicators located along the rail-system such that they are detectable by the detection means of the vehicle, for localization purposes of the vehicle.

By using the location-indicators, the vehicle position in the pallet rack can be determined, and can be stored in a memory or transmitted to a computer system together with scanned information of the pallets, thereby allowing to locate a certain item or pallet in the rack. Having location indicators offers the advantage that the vehicle is offered accurate localization information, without having to resort to information on the pallets, or distance measurements, or the like. The number of location indicators can be increased or decreased depending on the location accuracy required.

In embodiments of the inventory monitoring system of the present invention, the rail system may comprise at least one switch for switching between tracks portions.

It is an advantage of embodiments according to the present invention that, the rail system can comprise a number of tracks having switches allowing to more directly guide the vehicle to a certain location and/or to exclude part of the route.

It is an advantage of embodiments of the present invention that in case of an error (e.g. damage) in one of the tracks, such a part can be excluded from the route to be travelled. By using switches, redundant track partitions may be added, and the reliability of the system increased by providing alternative routing.

In embodiments of the inventory monitoring system of the present invention, the vehicle comprises a motor, e.g. an electric motor or small 2-tact or 4-tact engine.

This offers the advantage that the vehicle can move quite autonomously without the need for external driving means such as chains or belts. This reduces the number of moving parts to a minimum, and increases system reliability.

In embodiments of the inventory monitoring system of the present invention, the detection means comprises an RFID-reader for reading RFID-tags present on the pallets, and the vehicle further comprises at least one RFID-antenna. Alternatively, the detection means may comprise a mobil barcode scanner whereby, when the label is in the line of sight, scanning can be performed.

It is an advantage of RF-technology, in particular RFID-readers that no line of sight is required for detecting information, and that the reader need not be directed towards the target (as opposed to a barcode-reader for example).

In embodiments of the inventory monitoring system of the present invention, the vehicle comprises an omni-directional RFID-antenna.

It is an advantage that such an antenna can read RFID's located in the neighborhood of the vehicle, independent of its exact position w.r.t. the vehicle (above/below, left/right, front/back), even when the vehicle is not exactly positioned with respect to the antenna.

In embodiments of the inventory monitoring system of the present invention, the vehicle comprises at least two directional RFID-antennas.

By using such antennas, the location of the pallets can be determined with higher accuracy, if required or desired. The antennas may be activated separately. A particular use of such antennas is when the vehicle switches orientation (upside down) when changing levels in the pallet-rack. In this case the directional antennas are preferably directed in opposite directions, e.g. for “looking down” and “looking up” in the pallet rack.

In embodiments of the inventory monitoring system of the present invention, the rail system comprises an elongated profile mounted to the pallet-rack, and the vehicle comprises holding means for movably mounting the vehicle to the elongated profile.

The elongated profile may be composed of a plurality of straight or curved profiles, segments or portions. The lengths of these profiles are known beforehand, given the type of the pallet rack and the supplier. In this way modular rail systems can be built, and dimensioned just like the pallet racks themselves.

In embodiments of the inventory monitoring system of the present invention, the holding means is adapted for holding the vehicle at a predefined distance from the elongated profile in any orientation of the elongated profile.

A vehicle with such holding means can move on top of the rail, hanging upside-down the rail, climbing up or down an inclined rail portion, and even climbing up or down a vertical rail portion.

In embodiments of the inventory monitoring system of the present invention, the elongated profile is a tubular profile having a substantially rectangular, circular or hexagonal cross-section.

It is an advantage of tubular profiles that they are relatively lightweight yet provide sufficient strength against bending under their own weight and the weight of the vehicle.

A tubular profile with a circular cross section offers the additional advantage that the vehicle may change its position w.r.t. the rail profile (e.g. by making a 180° helical movement around the profile) for achieving a same orientation (e.g. “hanging below” instead of “standing on”), without the profile itself showing a torsion section.

In embodiments of the inventory monitoring system of the present invention, the elongated profile may have a T-shaped or I-shaped cross-section.

It is an advantage of such a profile that it is relatively lightweight yet provides sufficient strength against bending under its own weight and the weight of the vehicle. The elongated profiles also may be hollow tube shape profiles that can be relatively easy machined (e.g. rolled) to make turns, such as e.g. planar turns. This is especially true for elongated profiles made of metal or metal alloys such as aluminum.

In embodiments of the inventory monitoring system of the present invention, the vehicle further comprises a first wheel drivable by the motor, e.g. electrical motor, and mounted to the elongated profile for moving the vehicle along the elongated profile, the first wheel being movable with respect to the holding means for guaranteeing contact with the elongated profile also when the profile is curved.

It is an advantage of providing a movable first wheel, that the holding means have adjustable dimensions for providing and maintaining a firm grip with the elongated profile, even if the latter is curved.

In embodiments of the inventory monitoring system of the present invention, the elongated profile further comprises over at least part of its length a toothed rack, and the vehicle further comprises a toothed wheel arranged for engaging with the toothed rack, the toothed wheel being drivable by the motor, e.g. electrical motor.

It is an advantage of such a toothed rack and toothed wheel that guaranteed and efficient movement on an inclined rail portion, or even a vertical rail portion can be obtained.

In embodiments of the inventory monitoring system of the present invention, the vehicle furthermore comprises a first communication means for sending information of the scanned/monitored pallets to a computer system, the computer system comprising second communication means for receiving information sent by the vehicle.

An advantage of such communication means is that information scanned can be transmitted to the computer system almost immediately, offering a faster response time, and almost real-time behaviour. It is a further advantage of such communication means that the computer system can send information back to the vehicle, such as navigation commands.

The first and second communication means may comprise a first and second RF transceiver, such as e.g. a Wifi-transceiver.

Wifi offers the advantage over other wireless communication techniques (such as Bluetooth, or infrared) that it offers a relatively high data-throughput, works in the license-free ISM-band and is wide spread. But also other (new) low power communication standards and methods (e.g. 802.15, wireless sensor networks, wireless HART) could be used to transfer monitoring data and process-control data.

In embodiments of the inventory monitoring system of the present invention, the vehicle comprises a locomotive and at least one wagon, both being movably mounted to the rail system by means of holding means, the locomotive comprising at least a motor, e.g. an electrical motor, the at least one wagon being mechanically connected to the locomotive and comprising at least part of the detecting means.

The holding means may in one example comprise a plurality of ball casters.

An advantage of distributing the functionality of the vehicle over multiple carriages is that it allows the height of the vehicle to be limited (so as not to extend outside of the “dead zone”). It is a further advantage of increasing the length of the vehicle so that parts can be physically separated for avoiding disturbances. Furthermore, a locomotive and wagons allow flexible movement, in particular for making turns with a relatively short radius (e.g. smaller than 100 cm).

In a specific example, the vehicle consists of three parts electrically and mechanically connected together: a locomotive comprising the motor, e.g. the electrical motor, the first wheel and the toothed wheel, and a battery; a first wagon comprising an RFID reader and a Wifi-transceiver; and a second wagon comprising at least one RFID antenna. This is an example of a possible partitioning of the functionality over multiple wagons, but other partitionings of the functionality of the vehicle may also work.

In a second aspect of the present invention, a method is provided for monitoring items stored in a pallet rack using the inventory monitoring system as described above, the method comprising the steps of: a) moving the vehicle on the rail system through the pallet rack; b) detecting at least one pallet positioned close to the rail system.

In a third aspect of the present invention, a kit of parts is provided, comprising:—a rail system mountable to a pallet rack for forming at least one track for guiding at least one vehicle for scanning/monitoring the pallets;—at least one vehicle movably mountable to the rail system, and being adapted for moving over the rail system, and detection means for detecting information of the pallets which are located in the vicinity of the rail system. Such detection means may comprise an RFID-reader for detecting information of the pallets.

In a fourth aspect of the present invention, a method is provided for upgrading an existing pallet rack to an inventory monitoring system, the method comprising the steps of: a) mounting a rail system to the existing pallet rack for forming at least one track for guiding at least one vehicle for scanning pallets, thereby locating the rail system at least partly inside a space defined by outer construction elements; b) movably mounting at least one vehicle to the rail system, the vehicle comprising detection means for detecting information of the pallets which are located in the vicinity of the rail system.

In yet another aspect, the present invention also relates to a kit of parts, comprising a rail system mountable to a construction for forming at least one track for guiding at least one vehicle at least one vehicle movably mountable to the rail system and being adapted for moving over the rail system, wherein the rail system comprises a track extending at least in a horizontal and a vertical direction with respect to the construction, and wherein the vehicle is adapted for ascending and descending the track.

The rail system may comprises a single three-dimensional track comprising a plurality of track portions whereby track portion located in different substantially horizontal planes are interconnected by upright track portions.

The rail system may comprise a single three-dimensional track extending over the plurality of substantially vertical planes, whereby track partitions located in different substantially vertical planes are interconnected by lying track portions.

The vehicle may furthermore comprise storage means for storing detected information.

The vehicle may furthermore comprise a first communication means for sending information to a computer system, the computer system comprising second communication means for receiving information sent by the vehicle.

The vehicle may comprise a motor.

The motor may be an electric motor and the rail system may comprise at least two conductors for providing electrical power to the vehicle. The vehicle may have sliding contacts for connecting to the conductors.

The rail system may comprise an elongated profile, and the vehicle may comprise holding means for movably mounting the vehicle to the elongated profile.

The vehicle may comprise a first wheel drivable by a motor and holding means for guaranteeing contact with the elongated profile also when the profile is curved, the first wheel being movable with respect to holding means. The holding means may comprise a plurality of ball casters to keep the vehicle close to the track.

A track portion of the rail system may comprise over at least part of its length a toothed rack and the vehicle may further comprise a toothed wheel arranged for engaging with the toothed rack, the toothed wheel being drivable by a motor, e.g. an electrical motor.

The ratio of the diameter of the toothed wheel versus the diameter of the first wheel may be less than 100%, preferably less than 80%, more preferably less than 60%, e.g. about 50%.

Dimensions of the toothed rack and of the toothed wheel and of the first wheel may be chosen for automatic disengagement of the first wheel from the rail profile at track locations where the toothed rack is present, and for automatic engagement of the first wheel to the rail profile at track locations where the toothed rack is absent.

End portions of the toothed rack may show a ramp.

In yet another aspect, the present invention also relates to a vehicle for moving on a rail, the vehicle comprising

a first frame comprising a set of wheels for moving on a railguide,

a second frame being fixed to a body part of the vehicle,

wherein the first frame is moveable in the second frame thus allowing the vehicle to deviate from a vertical orientation induced by gravity working on the vehicle. It is an advantage of embodiments of the present invention that such movement may allow for coping with e.g. a centripetal force induced by the movement of the vehicle on a curved track.

The first frame being moveable in the second frame may be induced by the first frame being suspended in the second frame, e.g. through spring suspension. In an alternative embodiment, the first frame may be rotatably mounted in the second frame, e.g. using roller bearings between the first frame and the second frame.

The frame-in-frame principle may be included in an inventory system or a kit of parts as described above.

In still another aspect, the present invention relates to a connector for connecting guiding rails. Such connectors may be part of the inventory system or a kit of parts as described above. The connector may be adapted for both mechanical connecting different rail portions, as well as to provide electrical connection between the rails. Furthermore, the connector may also be adapted for powering the rails.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 shows an example of a classical pallet-rack with substantially horizontal beams for storage of pallets.

FIG. 2 shows the pallet rack of FIG. 1 and a rail system as part of an inventory monitoring system according to aspects of the present invention, mounted thereto.

FIG. 3 shows the inventory monitoring system of FIG. 2 in top view.

FIG. 4 shows a variant of the inventory monitoring system of FIG. 3 in top view.

FIG. 5 shows the inventory monitoring system of FIG. 2 in side-view.

FIG. 6A shows the inventory monitoring system of FIG. 2 in perspective view.

FIG. 6B shows a cross section of a part of the rail system of FIG. 6A, where the vehicle is standing on top of the rail profile, in enlarged view.

FIG. 6C shows a cross section of a part of the rail system of FIG. 6A, where the vehicle is hanging below the rail profile, in enlarged view.

FIG. 6D shows (in gray) the space defined by the outer posts of the pallet rack.

FIG. 6E shows an example of an elongated T-profile making a turn.

FIG. 6F is a variant of FIG. 6D, whereby the interconnecting track portion extends over a smaller distance out of the pallet rack.

FIG. 6G shows a part of FIG. 6F in more detail.

FIG. 7 shows a schematic example of a rail making a turn comprising a curved portion, such that a vehicle hanging below the rail in a first horizontal plane, is also hanging below the rail in a second horizontal plane.

FIGS. 8A and 8B are examples of suspending bars which may optionally be used in the inventory monitoring system of FIG. 2, for mounting the rail system to the beams of the pallet-rack.

FIGS. 9A and 9B show an embodiment of a rail system as part of an inventory monitoring system according to aspects of the present invention. The figure shows four individual tracks located in substantially horizontal planes defined by the beams, in perspective view (FIG. 9A) and in side view (FIG. 9B). The substantially horizontal dead zones are indicated in gray in FIG. 9B.

FIG. 10 shows a variant of the rail system of FIG. 9A according to aspects of the present invention, whereby the individual tracks are interconnected by upright track portions to form a single 3D-track. The differences with FIG. 9A are indicated in thicker line width for illustrative purposes.

FIG. 11 shows a variant of the embodiment of FIG. 10 according to aspects of the present invention, whereby the single track is closed to form an endless loop. The difference with FIG. 10 is indicated in thicker line width for illustrative purposes.

FIG. 12 shows a front view of an embodiment of a rail system as part of a inventory monitoring system according to aspects of the present invention, mounted on a “drive-in” or “drive-through” pallet-rack. The substantially vertical dead zones are indicated in gray. The figure shows two stacked rows (bays) of four pallets high, and a rail system comprising vertical track portions. The dead zones are defined between the planes formed by beams located on top of each other.

FIG. 13 shows an embodiment of the rail system of FIG. 12 in perspective view, whereby the rail system comprises three individual tracks located in three substantially vertical planes.

FIG. 14 shows a variant of the rail system of FIG. 13, whereby the individual tracks are interconnected on top of the pallet rack to form a single track with two end positions.

FIG. 15 shows another variant of the rail system of FIG. 13, whereby the individual tracks are interconnected to form a single track with three end points, and comprising a switch between some of the track portions.

FIG. 16 shows another variant of the rail system of FIG. 13, whereby the individual tracks have mainly upright track portions.

FIG. 17 shows a variant of the embodiment of FIG. 12 whereby the dead zones are defined between the upright posts.

FIG. 18 shows an an embodiment of the rail system of FIG. 17 in perspective view, whereby the rail system comprises three individual tracks located in three substantially vertical planes.

FIG. 19 shows an schematic cross-sectional drawing of an example of a T-shape rail profile and a first embodiment of a vehicle mounted thereto, according to aspects of the present invention.

FIG. 20 shows an exploded view of parts of the vehicle of FIG. 19.

FIG. 21 shows a side view of the parts of the vehicle shown in FIG. 19.

FIG. 22 shows a schematic cross-sectional drawing of an example of a tubular rail profile and a second embodiment of a vehicle mounted thereto, according to aspects of the present invention.

FIG. 23 shows a variant of the vehicle of FIG. 22 mounted on a tubular rail profile. This vehicle has sliding contacts, and the rail profile has power conductors.

FIG. 24 shows an example of a tubular rail system comprising the rail profile of FIG. 23, and the guiding rail mounted thereto. Toothed parts of the guiding rail are indicated in full black.

FIG. 25 shows an example of the relative positions of the first wheel and the toothed wheel of a vehicle relative to a rail profile without toothed rack (left), and on a rail profile with toothed rack (right).

FIG. 26 shows an example of a vehicle comprising a locomotive and two wagons according to aspects of the present invention.

FIG. 27 illustrates a vehicle comprising a handling means, according to an embodiment of the present invention.

FIG. 28 illustrates a clamping system for fixing the tracks or rails of the system to construction elements, according to an embodiment of the present invention.

FIG. 29 illustrates a locomotive and wagon connected via a flexible connection means according to an embodiment of the present invention.

FIG. 30 and FIG. 31 illustrate different tracks based on different profiles for use with different orientations of the paths, as can be applied in embodiments according to the present invention.

FIG. 32 and FIG. 33 illustrate wheels and the positioning thereof, as can be used in embodiments of the present invention.

FIG. 34 illustrates a manner for positioning a vehicle on a track, as can be applied in embodiments according to the present invention.

FIG. 35 to FIG. 36 illustrate an alternative suspension system for a device according to embodiments of the present invention.

FIG. 37 illustrates a connector piece for connecting rails, as can be used in an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope. In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention. Some part of the rail system, especially parts with curved portions may be deliberately drawn disconnected or in thicker line width for illustrative purposes.

Furthermore, the terms first, second and the like in the description and in the claims, are used fordistinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Where in embodiments of the present invention reference is made to “front side of a pallet-rack”, reference is made to the side of the pallet-rack where pallets are loaded. The opposite side of the pallet-rack is the “rear side” of the pallet rack. The pallet-rack may be unloaded from the front side or from the rear side.

Where reference is made to a helical structure, reference is made to a curvature that extends outside a plane, i.e. that extends in three dimensions simultaneously.

With “individual tracks” located in a substantially horizontal/vertical plane, is meant that the tracks are not interconnected, so that a vehicle in one plane cannot travel to another plane.

With “upright track portions” is meant track portions having locations that are not all at the same height. Examples are vertical track portions, or inclined track portions (e.g. showing an angle between 10° and 80° with respect to the direction of the gravity force).

Where reference is made to “dead space” or “dead zone” or “lost space” of a pallet rack, reference is made to the spatial area inside the pallet rack which cannot be used for storing pallets.

Where reference is made to “monitoring”, reference is made to scanning or detecting the presence of items (such as pallets or boxes, or items within a pallet or box), and retrieving information therefrom, such as an identification code. In addition or alternatively, information can be registered regarding the temperature, humidity, or another environmental parameter for the environment near the item.

In this application, the terms “rail track” and “track” are used as synonyms.

In this application, the terms “track portions” and “track segments” are used as synonyms, to indicate certain parts of a track.

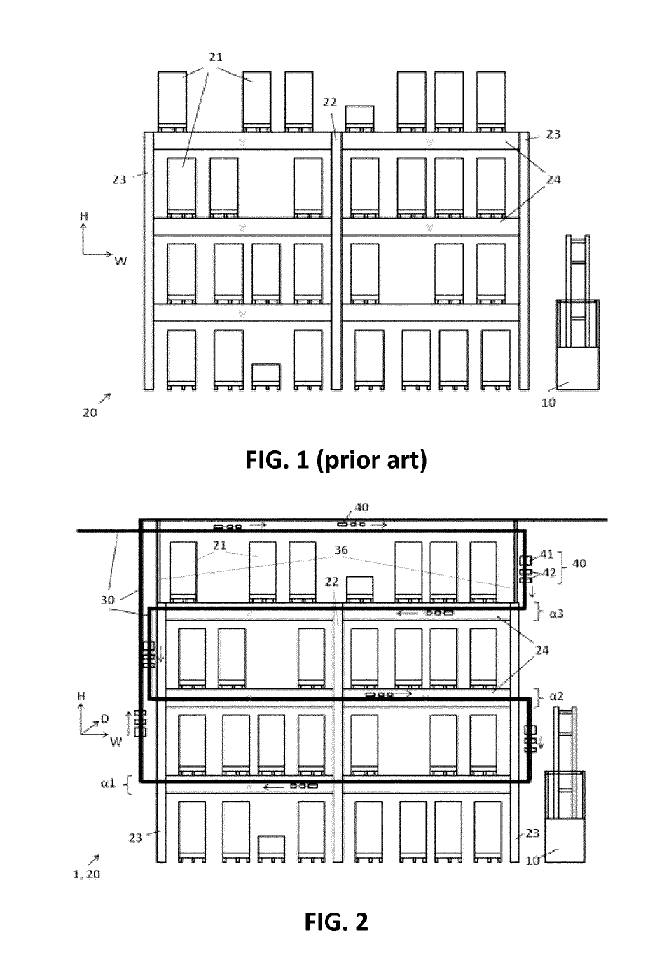

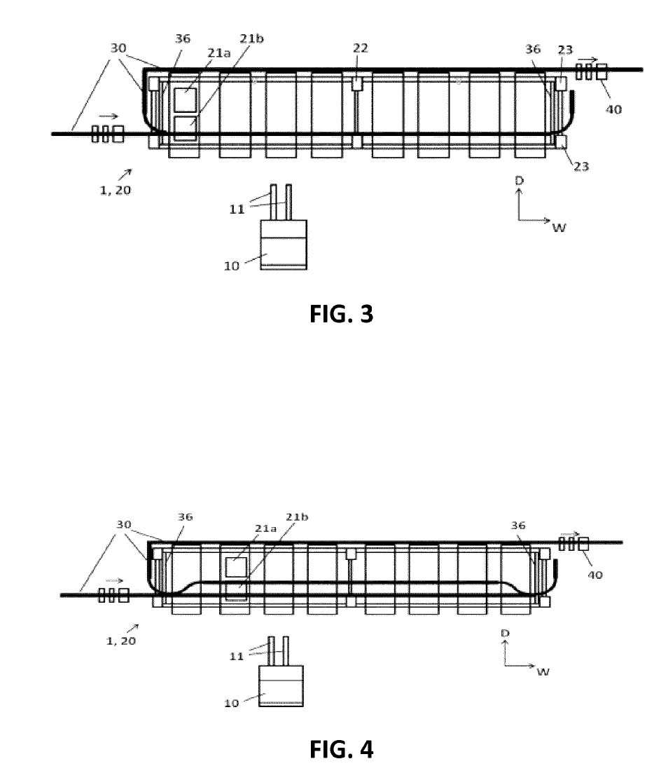

FIG. 1 shows an example of a classical pallet-rack 20, in front view, the pallet rack 20 having substantially horizontal, e.g. horizontal beams 24 upon which pallets 21 are stored. On the right of FIG. 1 also a forklift 10 is shown, oriented for loading/unloading pallets in/from the pallet-rack (the forks are not visible, because they are oriented in the depth direction). The forklift 10 is only shown for illustrative purposes. A known method for stock-taking of the pallets 21 in this pallet-rack 20 is to unload all the pallets 21 from the rack to ground level, one by one, and then scanning the pallets 21 manually using a barcode reader or an RFID reader, and then storing the pallets 21 back in the rack 20. This is clearly a time-consuming task. Another known method is to scan the pallets 21 manually while they remain stored in the rack, by climbing in the pallet-rack 20 and/or using a ladder or other lifting means. This is not only time-consuming, but may be also a dangerous task. In addition normal warehouse operations (loading and unloading pallets) need to be stalled as long as stock-taking or monitoring or searching a pallet 21, etc is busy. The main construction elements of the pallet rack 20 are vertical outer posts 23 (located at the four corners of the pallet rack), vertical intermediate posts 22 located between the outer posts 23, and horizontal beams 24, mounted to the vertical posts 22, 23. Assuming the pallet rack is two pallets deep (see FIG. 3), the pallet rack shown in FIG. 1 has 2 (deep)×8 (wide)×4 (high)=64 pallet storage locations, but pallet racks 20 with much more storage locations, e.g. 1,000 storage locations or even more, also exist.

In a first aspect, embodiments of the present invention relate to an inventory monitoring system for monitoring items stored in a pallet rack. The inventory monitoring system comprises a pallet rack comprising a plurality of construction elements for storing a plurality of pallets, a rail system mounted to the pallet rack and forming at least one track for guiding at least one vehicle for scanning the pallets, the rail system being located at least partly inside a space defined by outer construction elements and at least one vehicle being movably mountable to the rail system and adapted for moving over the rail system. The vehicle comprising detection means for detecting information of the pallets which are located in the vicinity of the rail system. FIG. 2 shows the pallet rack of FIG. 1, with a rail system according to an example of an embodiment of the present invention.

By way of illustration, embodiments of the present invention not being limited thereto, standard and optional features of the system will further be identified and described with reference to one or more exemplary systems according to at least one embodiment and with reference to the drawings of the present description.

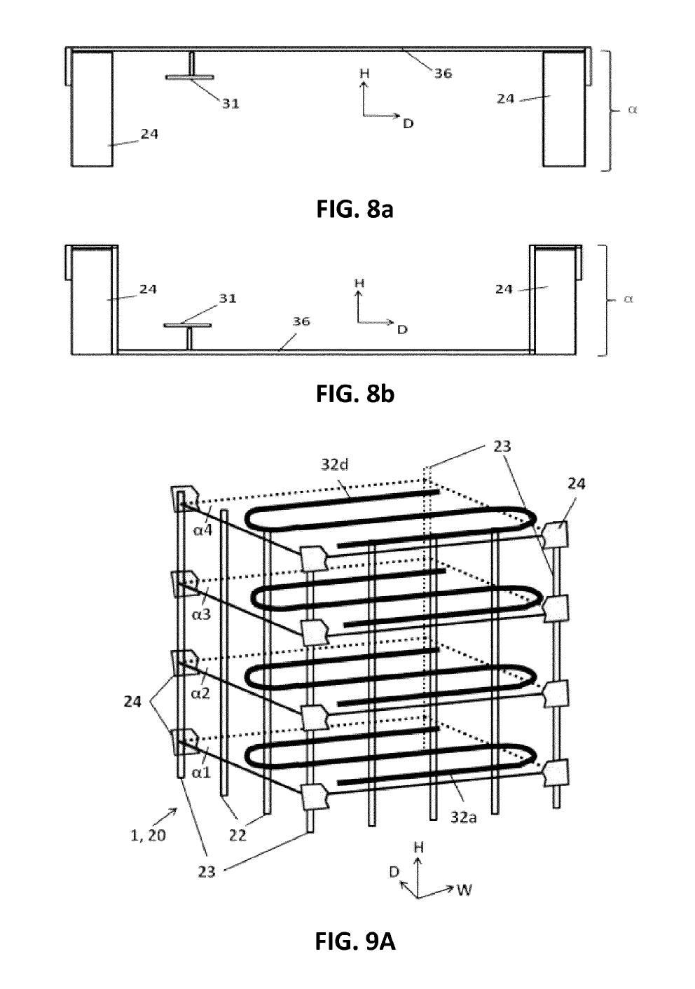

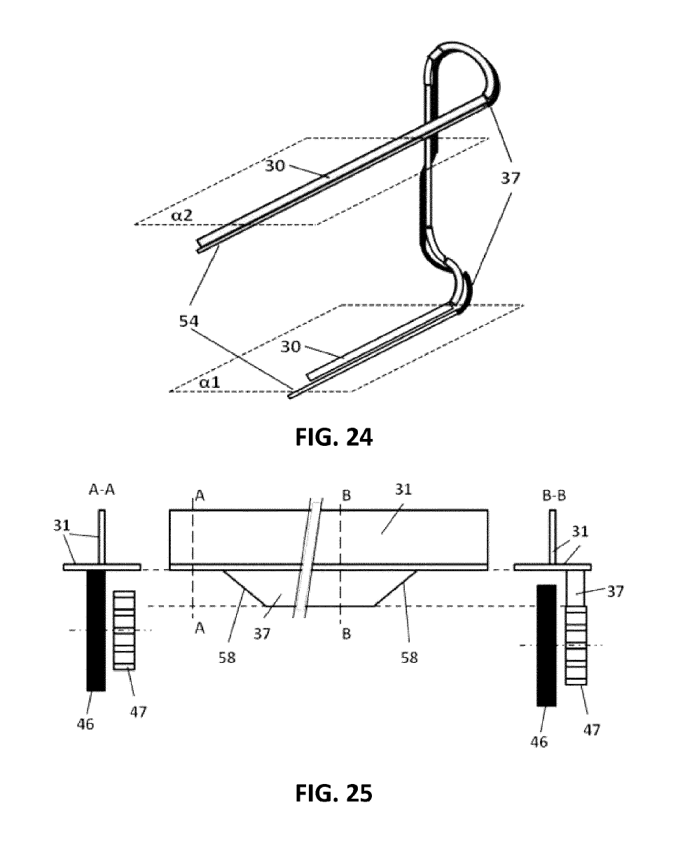

The inventory system 1, according to the example shown, comprises a rail system 30, mounted to the pallet rack 20, e.g. mounted to the upright posts 22, 23, or to the beams 24, e.g. via supports 36 (see FIG. 8A, 8B for example). The rail system 30 forms at least one track, e.g. a monorail, for guiding at least one vehicle 40. In FIG. 2 multiple vehicles 40 are shown for illustrative purposes, to show track portions where the vehicle stands on top of the rail 30, ascends or descends an upright track portion, or hangs from the rail. In case the track portions are interconnected, a single vehicle 40 may also be used for moving over the entire length of the rail for scanning, detecting or monitoring all pallets 21 in the rack 20. The track or tracks or track portions or track segments extend in at least two, preferably three dimensions, for enabling the vehicle(s) 40 to move along the rail 30, close to each pallet 21, thereby increasing the reliability and correctness of detection and scanning The vehicle 40 may move upwards, downwards, drive on top of the rail 30, or hang below the rail 30, as indicated by the arrows in FIG. 2, but the vehicle 40 may also mount or descend an inclined track portion (not shown), e.g. a track portion under an angle of 45° to a horizontal plane. Thereto the vehicle 40 may have specially adapted holding means 43 adapted to the rail profile 31 being used, as will be described further in relation to FIGS. 19 to 23. In FIG. 2 the track 30 may seem to have sharp corners of 90°, but in practice typically the corners will be made through curved tracks, not shown as FIG. 2 is only a two-dimensional projection. In reality the track 30 may have curved track portions, e.g. having a radius in the range of 10 cm to 100 cm, allowing the vehicle 40 to move inside a plane (left, right) and outside a plane (up, down). The track 30 may thus have combinations of straight parts, curved parts, torsion parts, helical parts, etc (see e.g. FIGS. 7 and 24, illustrating curved parts).

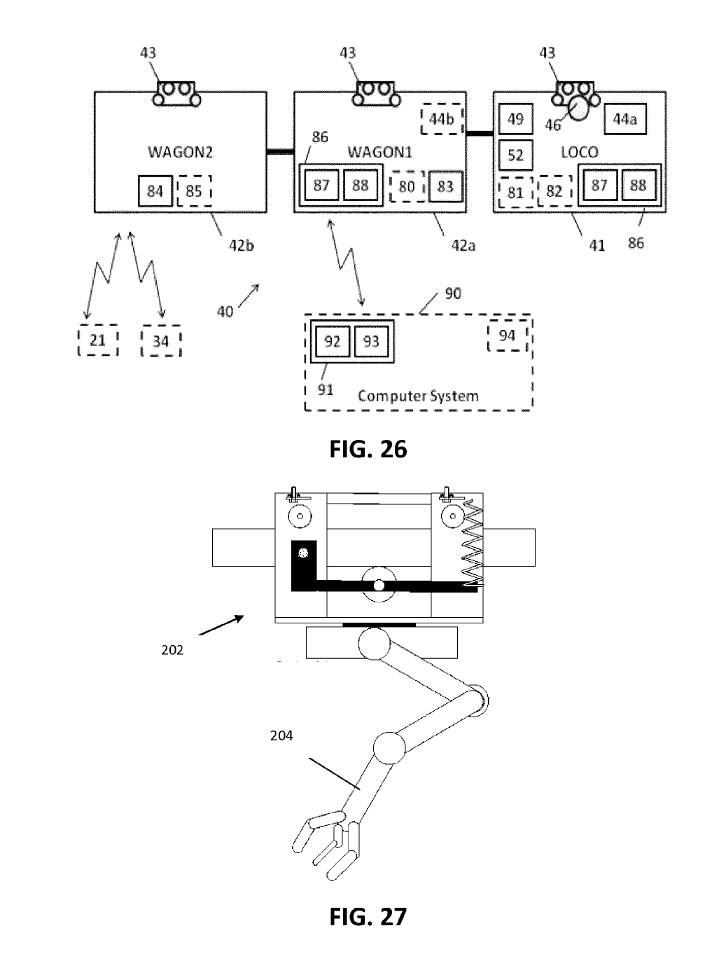

The exemplary vehicle shown in FIG. 2 comprises of three parts which are functionally (electrically and mechanically) connected together: a locomotive 41 and two wagons 42. By using multiple carriages instead of a single carriage, the functionality of the vehicle 40 can be distributed, while keeping the dimensions of the vehicle under control, especially the dimensions of its height and width. This offers advantages for moving the vehicle 40 over curved parts of the track 30. An example of a particular configuration of the vehicle 40 will be described in more detail later in relation to FIG. 26. It suffices for now to know that the locomotive 41 may have a control unit 97, e.g. a microcontroller for controlling the vehicle movement, a battery 44 and a motor, e.g. an electrical motor 49 for moving the vehicle 40 along the rail 30. Alternatively, instead of using a motor, e.g. an electrical motor, the vehicle 4 also may be moved using magnetic driving, e.g. based on a magnetization levitation technique.

The vehicle 40 is adapted for moving from a first position, e.g. a start position, to a second position, e.g. an end position on the rail 30, and for scanning the pallets 21 that it encounters (e.g. underneath, or above, or on the side of the track 30). The vehicle 40 has detection means 79, e.g. scanning means, e.g. a barcode-reader 80, e.g. an RFID-reader 83, for scanning information of the pallets 21, or boxes, or items present therein. The vehicle 40 may also have first communication means 86, e.g. a Wifi-transmitter or Wifi transceiver for sending information of the scanned pallets 21 to a computer system 90 (not shown in FIG. 2), and (in case of the Wifi-transceiver) for receiving information from the computer system 90, e.g. navigation commands. The computer system 90 which may or may not be part of the inventory monitoring system 1. The computer system has second communication means 91, e.g. a Wifi receiver or a Wifi transceiver, for receiving the information sent by the first communication means 86 of the vehicle 40, and may comprise a database 94 for storing the information, and may have processing means or processing the received information, such as e.g. removing duplicate information. Instead of or in addition to the first communication means 86, the vehicle 40 may also have storage means for storing the detected information, which information may be retrieved from the vehicle 40 e.g. by manually removing the storage means, or by transmitting the information via a connector (e.g. via a serial or parallel protocol), or e.g. via a modem. The latter may e.g. be functionally connected to electrical conductors via sliding contacts, located e.g. at the end position of the track 30, for powering.

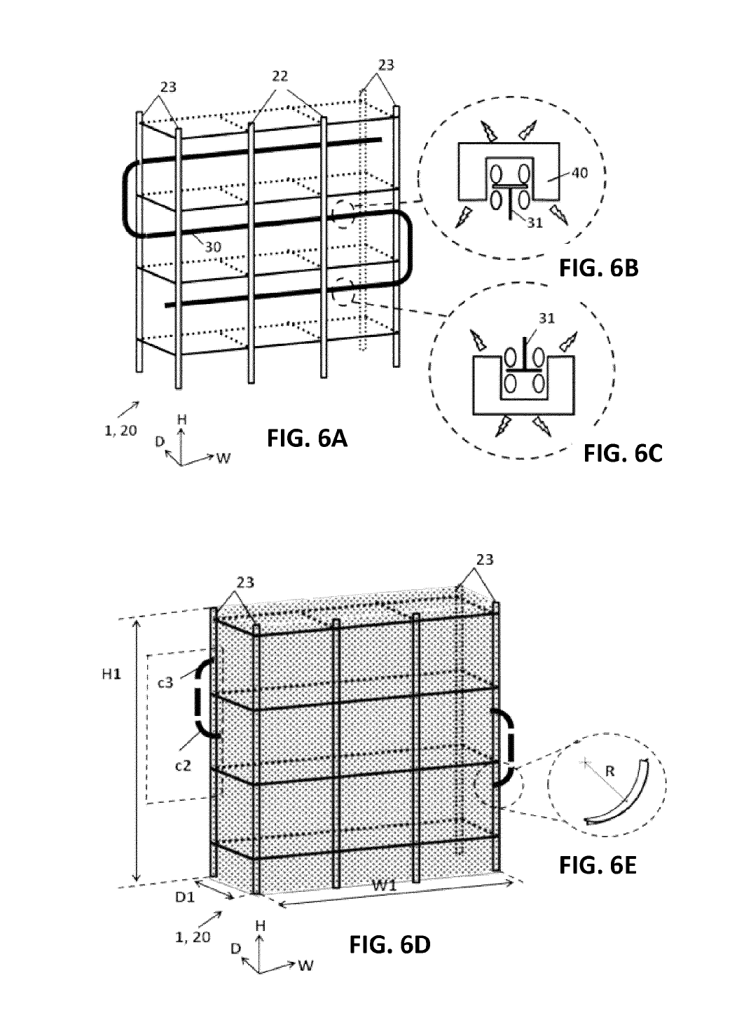

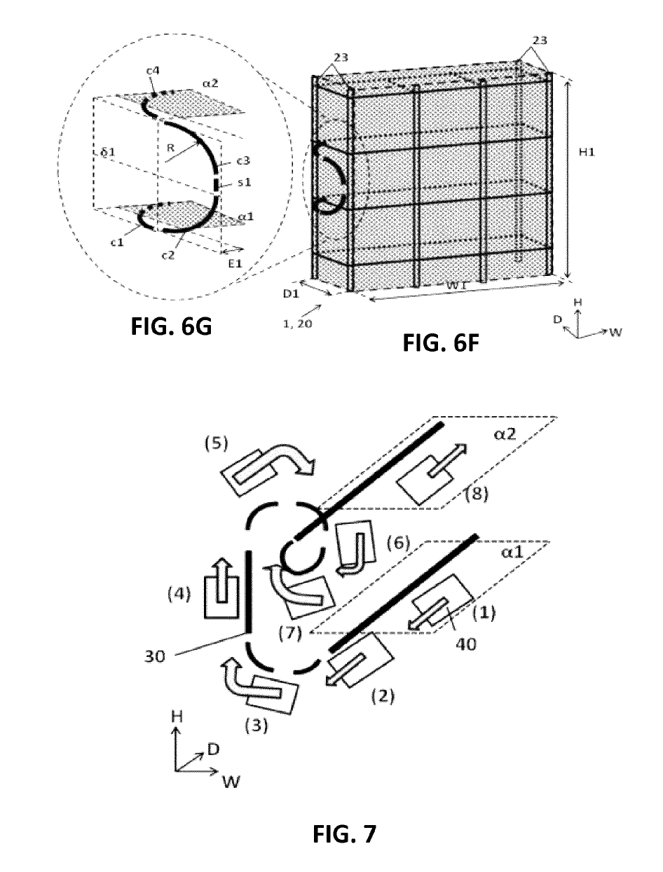

The exemplary pallet-rack 20 of FIG. 2 has a plurality of upright, e.g. vertical posts 22, 23, (whereby the reference 23 is used for indicating the four outermost posts, and reference 22 is used for intermediate posts), to which posts a plurality of substantially horizontal, e.g. horizontal beams 24 are mounted for supporting pallets 21. As shown in FIG. 2, the rail system 30 may be located partly, e.g. for more than 50%, preferably for more than 65%, more preferably for more than 80% inside the space defined by the four upright corner posts 23. This is also shown in FIG. 6D where the space defined by the outer construction elements, in particular the outer posts 23 of the pallet rack 20 is indicated in gray. As shown, only a very small track section extends outside of that space.

The track 30 of FIG. 2 is located mainly in substantially horizontal planes α1, α2, α3 formed by corresponding beams 24, i.e. beams 24 lying substantially at the same height (when neglecting any inclination as encountered e.g. in so called “push-back pallet-racks”). In this respect, the beams 24 forming a single level of the pallet rack may be considered corresponding beams. As the space between the beams 24 cannot be used to store pallets 21, it is considered in the art as “dead zones”, and this is exactly where the track 30 is preferably located in the rack 20. The track 30 may be located partly outside of these substantially horizontal planes, e.g. for moving from one plane α3 to another α2. Preferably the rail system 30 does not extend more than 20 cm, preferably not more than 10 cm on the side of the pallet-rack 20 for minimizing the risk of being damaged by forklifts 10 driving in the aisles close to the pallet-rack 20. This aspect will be further discussed in FIGS. 6F and 6G. The rail system 30 of FIG. 2 may extend in height direction D for allowing the pallets 21 on top of the pallet rack 20 also to be scanned from above (if so required or desired), and/or for allowing the vehicle 40 to move from one pallet rack 20 to another. This may also be a suitable location for a battery recharge station.

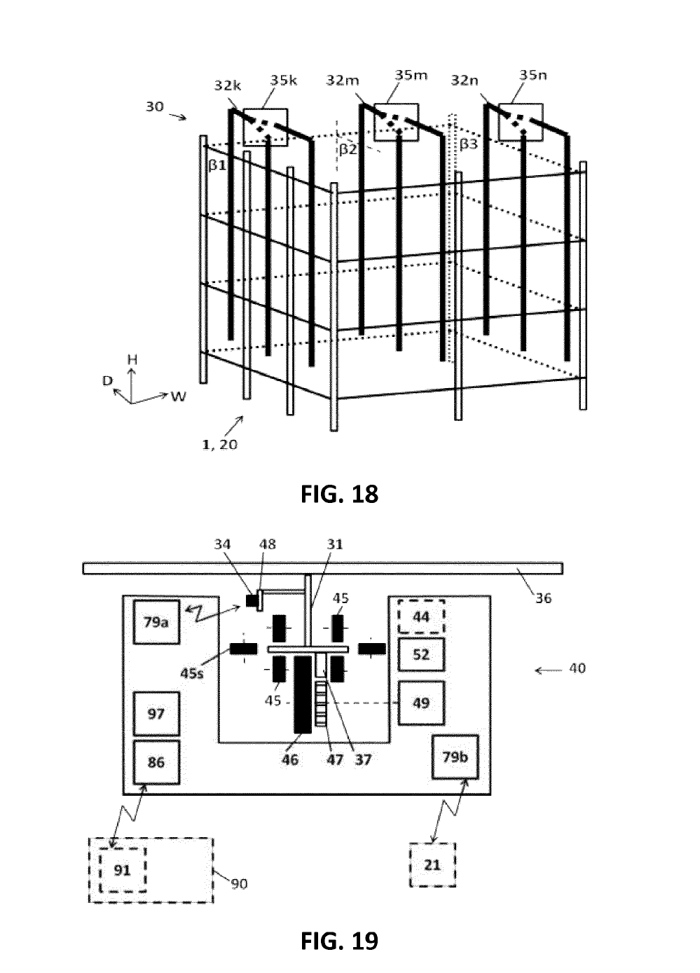

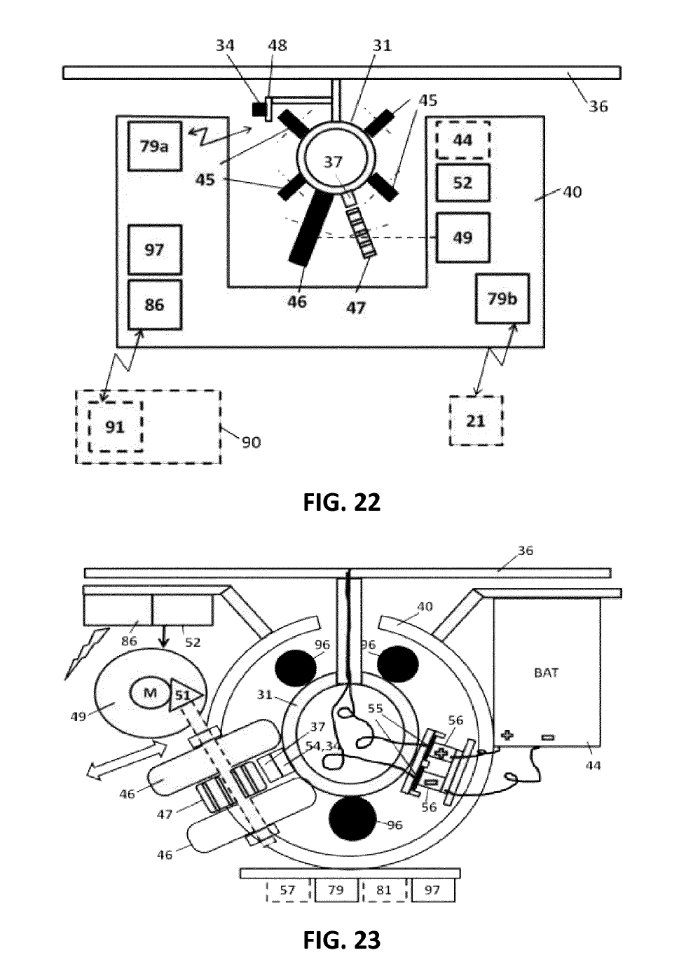

The rail system 30 may further comprise location indicators 34 (see FIGS. 19 and 22), e.g. barcodes or RFID-tags with location information, which can be read by the vehicle 40, so that it can determine its position along the track 30. The reading of such location indicators may require an additional reader, e.g. a dedicated barcode reader, or an additional antenna, e.g. a dedicated RFID-antenna. The location information may be sent to the computer system 90 along with the information of the scanned pallets 21, for storing not only the content of the pallets 21, but also their location in the pallet-rack 20. The location information may also be used by the computer-system for controlling e.g. any track switches 35 (see FIGS. 15 and 18) present in the rail system. Optionally the vehicle 40 may also have distance sensors 85 (not shown) for determining the distance between the vehicle 40 and the pallets 21. The distance information can also be sent along with the scanned information to the computer system. Alternatively or in addition thereto, also further information such as one or more environmental parameters also can be registered, including temperature and/or humidity of the environment wherein the item is stored.

FIG. 3 shows the exemplary pallet-rack 20 of FIG. 2 in top view. It shows some of the curved portions of the pallet rack 20. Two vehicles 40 are shown in FIG. 3, but that is not absolutely necessary, and one single vehicle 40 may be sufficient for scanning the entire pallet-rack 20, if the rail system 30 comprises a single three-dimensional-track (3D-track), as will be described further.

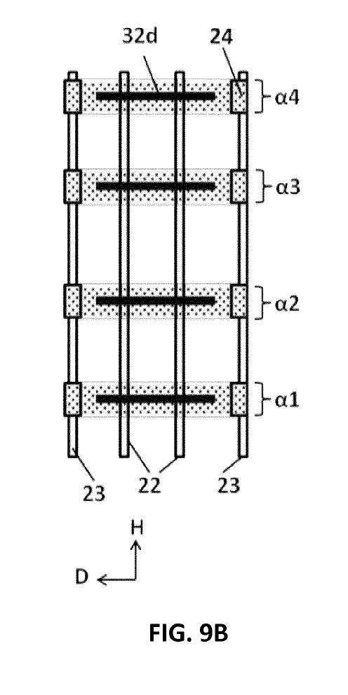

Note that the rail 30 does not need to pass exactly above each pallet. In FIG. 3 for example, the vehicle 40 will pass above the pallet 21b located at the front of the rack 30, but not exactly above the pallet 21a located in the back of the pallet rack 20. The skilled person can easily determine the maximum distance between each pallet and the track 30 for reliable detection, and if needed provide extra rail tracks (see FIG. 9A).

FIG. 4 shows a variant of the pallet-rack 20 of FIG. 3 in top view. The main difference with FIG. 3 is that the rail 30 is located closer to the middle of the rack 20, instead of being located closer to the front. This may allow better detection of the pallets 21a located at the back of the pallet rack 20. Other variants are of course also possible.

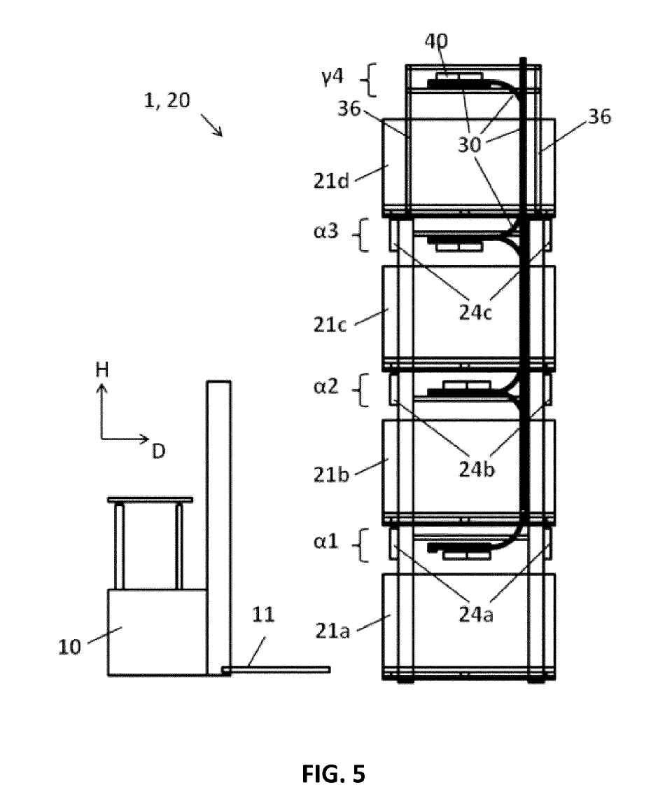

FIG. 5 shows the pallet rack 20 of FIGS. 2 and 4 in side-view. The rail track 30 is located substantially in the middle of the depth direction D of the rack 20. Note that the rail 30 is located mainly in the substantially horizontal planes α1, α2, α3, formed between pairs of corresponding beams 24a, 24b and 24c. An additional track portion is located in a substantially horizontal plane γ4 located on top of the pallet rack 20 for scanning the uppermost pallets 21d. Since there are no beams, this track portion is mounted to suspending bars 36.

Note that in the examples of the rail system 30 shown so far, the vehicle 40 is hanging from the rail 30 when it is in the planes α1 and α3, and is standing on the rail 30 when it is in the planes α2 and γ4. In other words, in this example of the rail system 30, the vehicle changes orientation (“up”/“down”) each time it changes a level in the pallet-rack 20. Without proper measures, reliably scanning all the pallet 21 may not be possible when using a vehicle 40 with detection means 79, e.g. a barcode reader 80 fixedly mounted to the vehicle 40, and may not be optimal for detecting all the pallets 21 with a single directional RFID antenna 84. Assuming the detection means 79 is based on RF-technology, e.g. RFID-technology, there are several solutions for solving this problem: (a) to use one or more omni-directional antennas on the vehicle 40, such that the vehicle can “look up” for detecting/scanning pallets 21 located above the rail 30, and “look down” for detecting/scanning pallets 21 located underneath the rail 30, (b) to use a first directional antenna for “looking down” and a second directional antenna for “looking up”, whereby one or both of the antennas may be activated at the same time. These solutions are schematically illustrated by the FIGS. 6A-6C. Another possibility (c) is to provide a rail system (30) such that the vehicle 40 is always oriented in the same way towards the pallets 21 (e.g. “hanging” from a rail located above the pallets). FIGS. 7 and 24 show such a rail system 30, whereby the track 30 comprises a rail portion that makes a torsion of 180° around its longitudinal axis, e.g. by means of a helical shape. Indeed, FIG. 7 shows a vehicle 40 (represented in this case by a single carriage) “hanging” from the rail 30 in both a lower plane α1 and a higher plane α2, which may be advantageous for scanning labels, e.g. barcode labels or RFID labels located on top of the pallet 21 from above. Compared to the rail-system 30 and vehicle of FIGS. 6A-6G, the curvature of the rail system 30 of FIG. 7 is more complex and may require more space (mainly outside of the pallet rack), but the detection means 79 of the vehicle 40 may be simpler, e.g. only one reader and one antenna may be sufficient. The skilled person can make a suitable trade-off based on parameters such as e.g. complexity, availability and cost of the rail-profiles 31 for building such a rail system, available space between the pallet racks 20 in the warehouse, versus complexity, availability and cost of the detection means 79, e.g. reader(s) and antenna(s), and space available on the vehicle 40.

When comparing the rail system 30 of FIGS. 6F and 6G with the rail system 30 of FIGS. 6D and 6E, it becomes clear that the interconnection parts between track portions at two different levels in FIGS. 6D and 6E have only two curved track portions c2, c3, which are located in an imaginary vertical plane substantially perpendicular to the depth direction D, and that these interconnection parts c2, c3 are located almost entirely outside of the space defined by the outer posts 23 (indicated in gray). Thus the track 30 extends over almost the entire radius R of the curvature, which may be 40 to 100 cm. It is an advantage of this rail configuration that it only requires two curved track portions c2, c3, however the extension outside of the pallet rack 20 may be relatively large. FIGS. 6F and 6G show another solution, whereby the interconnection parts between two levels have four curved track portions c1, c2, c3 and c4, the first curved track portion c1 being located in the lower substantially horizontal plane α1, the second and third curved track portions c2, c3 being located in an imaginary vertical plane δ1, substantially perpendicular to the width direction W, and the fourth curved track portion c4 located in the upper substantially horizontal plane α2. All four curved track portions c1-c4 may have the same radius R, e.g. 40 to 100 cm, but that is not absolutely required. Important however is that only a fraction of the radius R of the first and fourth portion c1, c2 extends outside of the space defined by the outer posts 23 (indicated in gray), for example only 10 or 20 cm, while a major portion, e.g. 80% of the curvature can be done inside the space defined by the outer posts 23. It is an advantage of the configuration of FIGS. 6F and 6G that it extends only over a fraction of the radius R of the curved track outside the pallet rack 20, thus providing almost no hinder to people walking, or forklifts 10 driving between the pallet-racks. Depending on the height difference between the lower plane α1 and upper plane α2, the interconnection part may also comprise straight track portions s1, as shown in FIG. 6G. Note that the track portions in FIGS. 6D, 6F, 6G are deliberately drawn separate, to clearly show the individual track portions.

FIGS. 8A and 8B are examples of suspending bars 36 or support bars 36 which may be used in the inventory monitoring system 1 of any of the FIGS. 2 to 6G, for mounting the rail system 30 to the beams 24 of the pallet-rack 20. FIG. 8A may be used in a substantially horizontal plane a where the vehicle 40 (not shown) hangs from the rail profile 31 so that the rail profile 31 and the vehicle 40 are both located inside the “dead zone” formed between the beams 24, without extending below the beams 24. Likewise, the support 36 shown in FIG. 8B may be used in a substantially horizontal plane a where the vehicle 40 (not shown) stands on the rail profile 31 without extending above the beams 24.

FIG. 9A and 9B show an embodiment of a rail system 30 having four individual tracks 32, each located in a substantially horizontal plane α1 to α4 defined by corresponding beams 24. Each individual track 32 extends in two dimensions W, D for allowing detection/scanning of all items stored above and/or below that substantially horizontal plane. The individual tracks 32 of FIG. 9A show a zig-zag or serpentine configuration, but other configurations are also possible, such as e.g. a comb-like structure with one or more switches (not shown in FIG. 9A). Each individual track portion 32a-32d has at least one, e.g. exactly one vehicle 40 (not shown). FIG. 9A is a perspective view, FIG. 9B is a side view. The substantially horizontal dead zones, referred to in this application as “substantially horizontal planes” α1 to α4 are indicated in gray in FIG. 9B. An advantage of a rail system 30 with individual tracks 32 may be that the vehicles 40 on them do not have to switch orientation (up/down), since they do not change levels. This may simplify the detection means 79, e.g. a single set of directional antennas 84 may be configured to “look” only “down”.

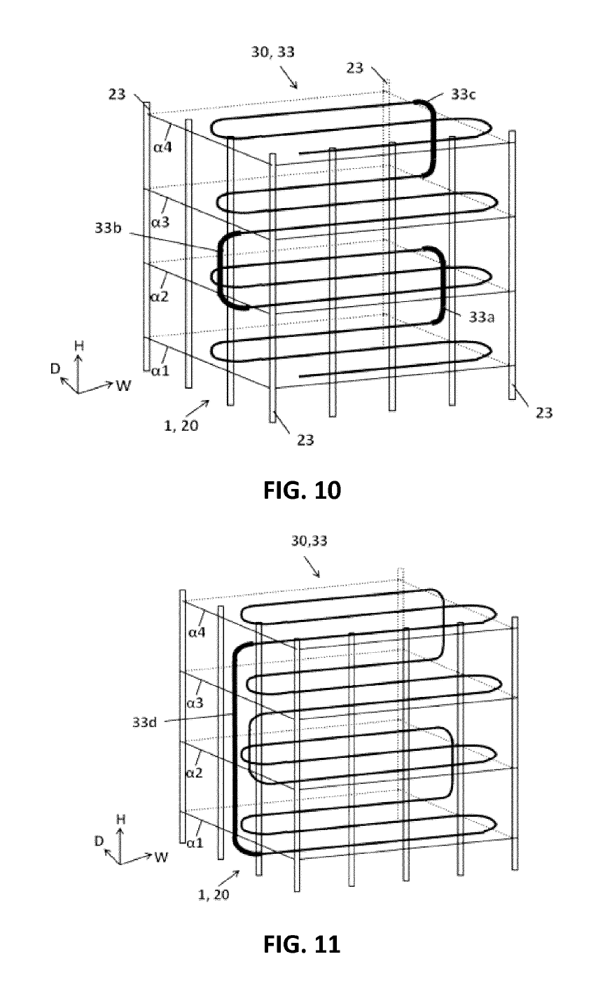

FIG. 10 shows a variant of the rail system 30 of FIG. 9, whereby the individual tracks 32a to 32d are interconnected by interconnection track portions 33a, 33b, 33c to form a single three-dimensional track 33. The differences with FIG. 9A are indicated in thicker line width for illustrative purposes. An advantage of the rail system 30, 33 of FIG. 10 is that a single vehicle 40 may be used to scan all items in the pallet rack 20, so that initial costs and maintenance costs of the inventory monitoring system 1 can be further reduced. Of course, multiple vehicles 40 may also be used in this rail system, if so desired. The interconnection track portions may be similar or identical to those shown in FIG. 6D and FIG. 6G.

In a variant of the inventory monitoring system 1 of FIG. 10 (not shown), not a single 3D-rail system 33 is provided running through all four planes α1 to α4, but two 3D-rail systems 33 are provided, each running through at least two planes. For example, the lower two planes al and α2 could be interconnected to form a lower 3D-rail system, and the upper two planes α3 and α4 could be interconnected to form an upper 3D-rail sub-system.

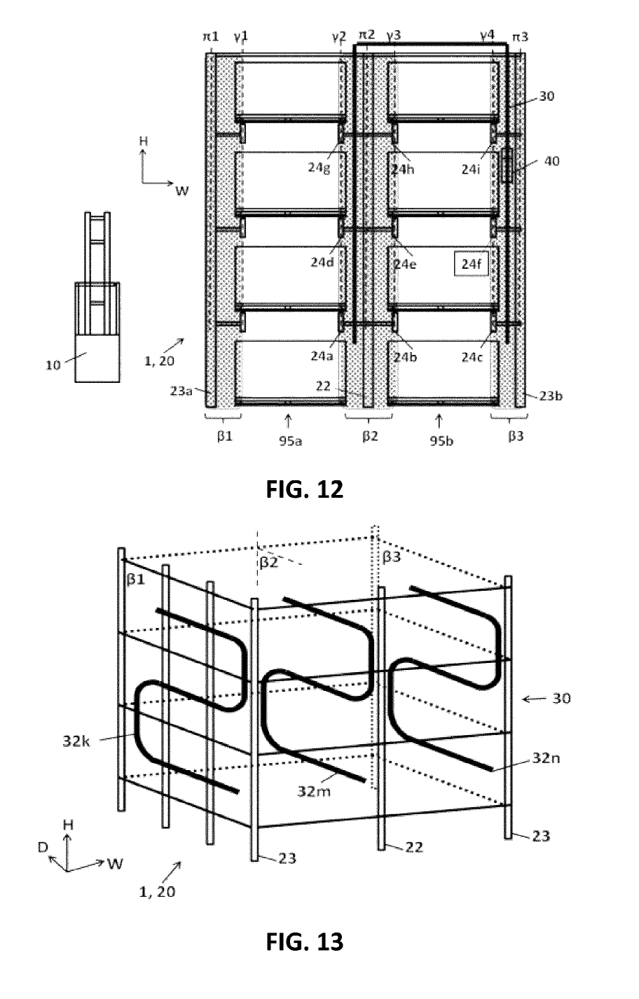

FIG. 11 shows a variant of the embodiment of FIG. 10 whereby the single three-dimensional track 33 of FIG. 10 is closed to form an endless loop, by adding another interconnection track portion 33d, indicated in thicker line width for illustrative purposes. This rail system 33 offers the advantage that the vehicle 40 may be driven in one direction only, e.g. only “forward”, whereas the vehicle 40 of FIG. 10 needs to be able to move “forward” and “backwards”, that is, without human intervention.

Whereas FIGS. 2 to 11 illustrate a first kind of pallet racks 20, having beams 24 oriented substantially perpendicular to the loading direction of pallets, FIGS. 12 to 18 will illustrate a second kind of pallet-racks 20, known as “drive-in” or “drive-through” pallet-rack, also having beams 24, but oriented substantially parallel to the loading direction of pallets 21. Other aspects that were discussed, such as features of the vehicle 40, are applicable to both kinds of rail systems, unless otherwise noted. The same applies to such features that will be discussed hereafter.

FIG. 12 shows such a “drive-in” or “drive-through” pallet rack 20 in front view, as suggested by the position of the forklift 10. The figure shows two stacked rows (known as “bays”) of four pallets high. In other words, the pallet rack 20 has four levels for stacking Unless otherwise noted, everything what is said for the rail system 30 and vehicle 40 above, is also applicable here.

As before, this pallet rack 20 also has upright posts 22, 23 and lying beams 24, but in contrast to the pallet racks 20 discussed before, this time a forklift 10 can drive between the beams 24, hence the name “drive-in” or “drive through” pallet rack. The inventor has however found that there are also “dead zones” β1 to β3 in this pallet rack 20, as indicated in gray.

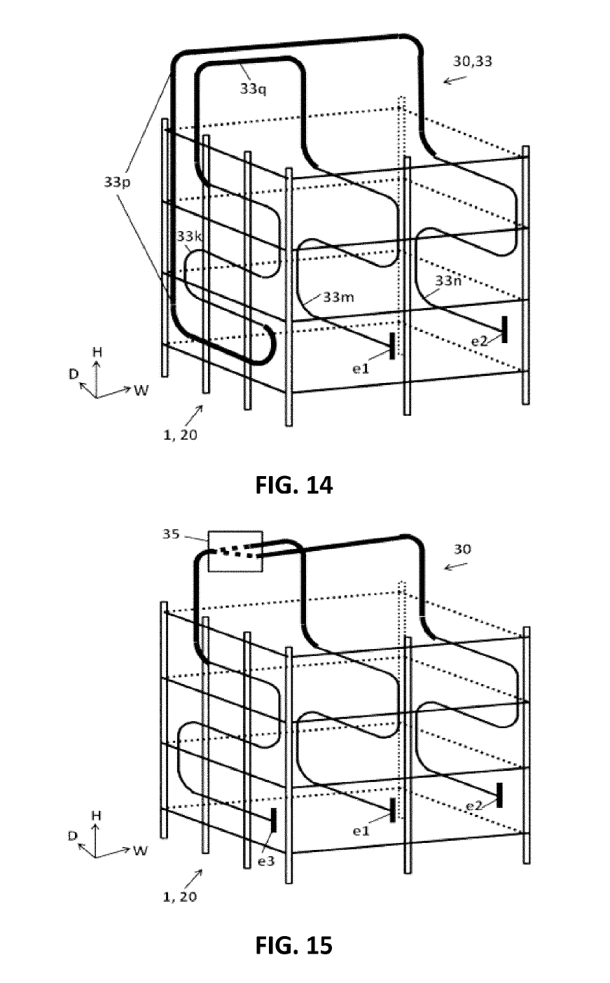

Indeed, when looking in more detail, it can be seen that beams 24 are located on top of each other and lying in substantially vertical planes γ1 to γ4. The planes formed by the upright posts 22, 23 and oriented in the depth direction D and height direction H of the rack, are denoted with references π1 to π3. The rail system 30 of the inventory monitoring system 1 of FIG. 12 is then preferably located mainly in the zones β1 to β3 formed between the vertical planes π1 and γ1, γ2 and γ3, and γ4 and π3 respectively, as indicated in gray, in other words, in the space between the imaginary planes formed by the posts 22, 23 and the beams connected to these posts. Although these zones β1 to β3 have in fact the shape of a parallelepiped or beam, they are called “substantially vertical planes” in the present application. By locating the rail system 30 in the “dead zones” β, the rail track 30 and the vehicle 40 are better protected against accidental damage e.g. from collisions with pallets 21, and occupy no useful space in the rack, and allow simultaneous monitoring/scanning and loading/unloading operations. The rail system 30 may extend above the pallet rack 20, again without hindering the forklift 10. The rail system 30 of FIG. 12 is shown in 2D-projection, and therefore the seemingly right angles of 90° do not correspond to real track curvature, some examples of which will be shown in FIGS. 13 to 16 in perspective view.

FIG. 13 shows a first example of a rail system 30 for the drive-in/drive-through kind of pallet rack 20 shown in FIG. 12. It comprises individual track portions 32k, 32m, 32n located in the substantially vertical planes β1, β2 and β3 respectively. Each individual track 32 may comprise at least one, e.g. one vehicle 40 (not shown) for detecting/scanning/inventarising the pallets 21 of one stacked row (or bay) 95. Note that the individual track portions 32 may be located between the planes γ and π (see FIG. 12), without extending outside the front or the back of the pallet rack 20, and without having to provide openings (holes) in the beams 22, 23, which could seriously reduce the rigidity and load bearing capacity of the pallet rack 20. The individual tracks 32 of FIG. 13 may have horizontal track segments, which offers the advantage that traveling of the vehicle over such track portions requires relatively low energy. This is especially useful for battery powered vehicles 40, since ascending/descending may require quite some energy.

FIG. 14 shows a variant of the rail system 30 of FIG. 13, whereby the individual tracks 42 are interconnected to form a single three-dimensional (3D) track 33. The differences with the track system 30 of FIG. 13 are shown in thicker line width. They may comprise e.g. interconnection tracks 33p, 33q and/or end positions e1, e2 to prevent the vehicle 40 from moving too far.

FIG. 15 shows another variant of the rail system 30 of FIG. 13, having two interconnection tracks and a switch 35, much like a railway switch, to allow a vehicle 40 to change tracks. Providing one or more switches 35 to the rail track 30 adds complexity, but may improve the speed of reaching certain pallet locations, by avoiding that the vehicle 40 has to travel over the entire track length, which may be considerable for pallet racks 20 having thousands of pallet storage locations. The switch 35 may be controlled by a computer system 90 (not shown), and may be controlled taking into account the actual position of the vehicle 40. As described before, location indicators 34, e.g. RFID-tags with location information may be present alongside the rail system 30 for indicating such positions (see FIG. 19 and FIG. 22).

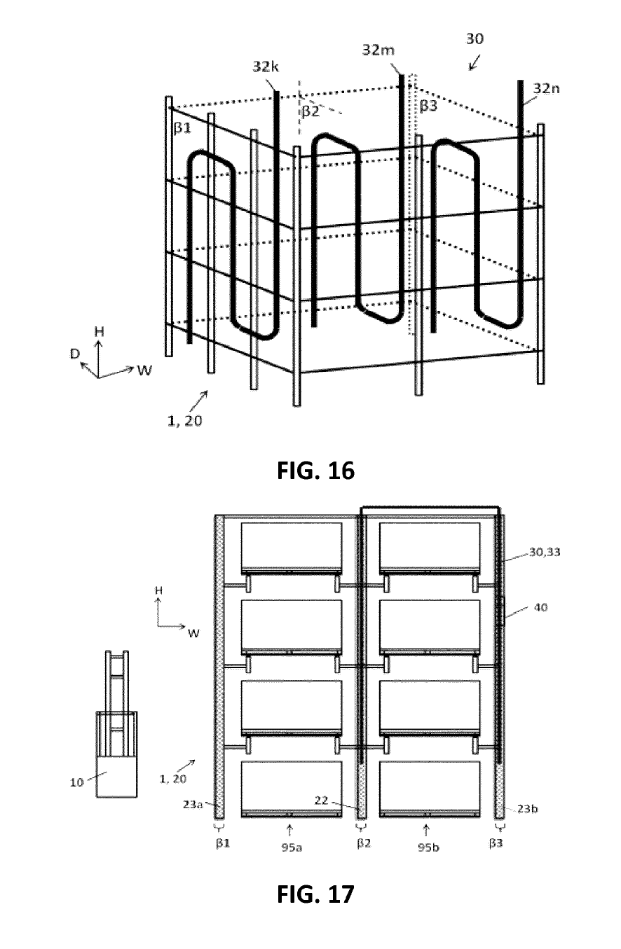

FIG. 16 shows another variant of the rail system 30 of FIG. 13, whereby the track segments are primarily upright, e.g. vertical.

Other configurations are of course also possible, e.g. where some track portions are horizontal, some are inclined (e.g. under an angle of 45° to the horizontal plane), some are vertical, and any combinations thereof.

FIG. 17 shows a variant of the rail system 30 of FIG. 12, whereby the “space defined by the upright posts” 22 and 23 themselves, i.e. the space comprised between two or more upright posts 22, 23 on the same side (e.g. left) of a bay 95, and extending over the width of the upright post profiles (typically I-beams or H-beams), e.g. 20 to 40 cm is considered as the “dead zones”. These are again indicated by references β1 to β3. Locating the track system 30 and the vehicle 40 within this space, again referred to as “substantially vertical plane” offers an even better protection to the track 30 and vehicle 40 as compared to the location shown in FIG. 12.

FIG. 18 shows a perspective view of such a rail system 30 comprising a plurality of upright, e.g. vertical track portions, interconnected with each other on top of the pallet rack 20, so as to form individual two-dimensional tracks 32k, 32m, 32n, each of which may comprise at least one, e.g. one vehicle 40. The tracks have a comb-like configuration and have a switch 35 to switch track portions.

In a variant of this configuration (not shown), the individual tracks 32 of the different planes may be interconnected, e.g. on top of the pallet rack 20, to form a single three-dimensional track 33.

Hereafter an exemplary first rail profile 31, in particular a T-profile and a corresponding vehicle 40 will be described with reference to FIGS. 19 to 21.

FIG. 19 shows an schematic cross-sectional drawing of an example of a T-shape rail profile 31 and a vehicle 40 mounted thereto, as may be used in any of the rail systems 20 described above. The vehicle 40 comprises a main wheel 46 and a toothed wheel 47, operatively connected to a motor 49, e.g. an electric motor, for moving the vehicle 40 over the rail track 30. The vehicle 40 further comprises a plurality of freely rotatable wheels 45 adapted for being positioned on top and bottom of the rail profile 31, and a plurality of freely rotatable wheels 45s adapted for being positioned on opposite sides of the T-profile 31. Note that for clarity reasons only the position of the wheels is shown, not how they are attached to the body/housing of the vehicle 40, which may occur in any way known. Together these wheels 45, 45s form the holding means 43 for holding the vehicle 40 in position with respect to the rail profile 31 in any orientation of the elongate profile 31, e.g. standing on the rail, hanging upside-down from the rail, when ascending or descending an upright, e.g. vertical track portion, when making a turn (left, right) in a horizontal plane, etc. The freely rotatable wheels 45 allow movement of the vehicle 40 in longitudinal direction of the rail profile 31 at minimal friction. However, other holding means 43 are also possible, e.g. a U-shaped profile made of a low-friction material (also known as “anti-friction materials) positioned around opposite sides of the T-profile, instead of the side wheels 45s. Preferably in that case the material of the holding means 43 and the material of the elongated profile 31 have a static friction coefficient smaller than 0.20, preferably less than 0.10. The wheels 45, 45s and motor 49 are mounted to a body (also called housing), which for simplicity is shown as a U-shape, but any other suitable shape may also be used.

The vehicle may further have a battery 44, preferably a rechargeable battery, and a motor controller 52 for controlling the motor 49, and detection means 79b, e.g. a barcode reader or an RFID reader for detecting/scanning pallets 21, and the same or a dedicated detection means 79a, e.g. a barcode reader or an RFID reader for detecting location indicators 34, and first communication means 86, e.g. an IR/Wifi-transmitter/transceiver for communicating with second communication means 91, e.g. an an IR/Wifi-receiver/transceiver of a computer system 90, and a control unit 97, e.g. a micro-processor for controlling the elements of the vehicle 40, and optionally for interpreting navigation commands sent by the computer system 90.

The rail 31 may be mounted to a rail support 36, examples of which have been described before in FIGS. 2-5 and FIGS. 8A and 8B. FIG. 22 also shows a location indicator holder 48, and a location indicator 34 mounted thereto. The location indicator 34 may be e.g. a barcode or an RFID-tag comprising position information, detectable by the vehicle 40 via its detection means 79a. The information locator holder 48 may be hollow or made of a suitable material, such as e.g. a non-metallic material, for not disturbing the signal sent by the location indicator 34 mounted thereon, especially if the location indicator 34 is an RFID-tag. The location information may be communicated to a computer system 90 via the first communication means 86, e.g. a Wifi-transceiver. The computer system 90 may be part of the inventory monitoring system 1, or may be external thereto.

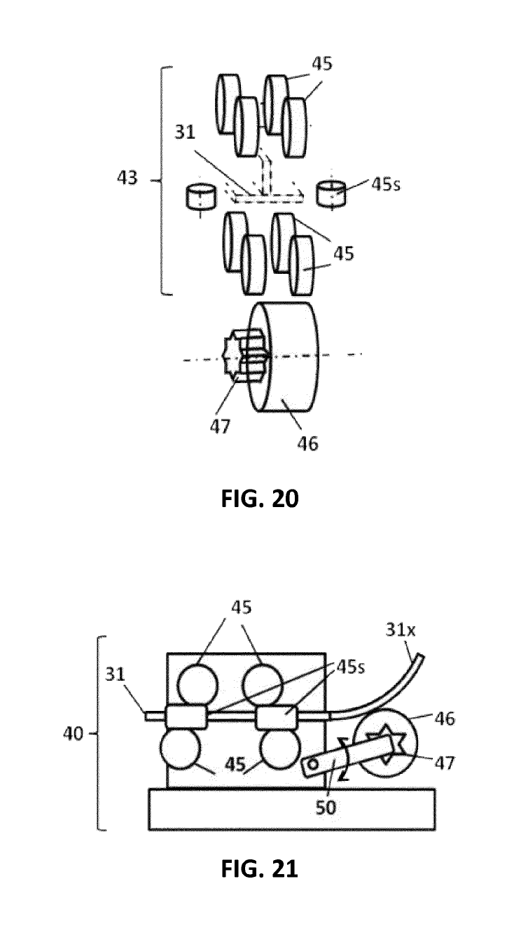

FIG. 20 shows an exploded and perspective view of parts of the vehicle 40 of FIG. 19, in particular parts of the holding means 43, and the first wheel 46, and the toothed wheel 47. The material of the first wheel 46 and the material of the elongated profile 31 may have a sliding friction coefficient larger than 0.50, preferably larger than 0.60 so that the risk of slipping of the first wheel 46 is minimized. The first wheel 46 may comprise rubber. The elongated profile 31 may comprise a coating layer for increasing friction with the first wheel 46.

FIG. 21 shows a side view of the parts of the vehicle 40 shown in FIGS. 19 and 20. The first wheel 46 and toothed wheel 47 may be mounted on a movable, e.g. rotatable arm 50, which may be pushed with a suitable force towards the rail profile 31 by means of springs. In this way a firm contact may be provided between the first wheel 46 and the rail profile 31, or between the toothed wheel 47 and a toothed rack 37 (not shown in FIG. 21). It is important that the wheels are movably mounted to guarantee good contact with different track segments, such as e.g. straight track segments, upwardly/downwardly curved track segments, etc. However, other holding means 43 are also possible, for example in a variant of the holding means shown in FIG. 21, the movable first and toothed wheel 46, 47 are located between the freely rotatable wheel 45. The skilled person may use also other variants as the holding means 43, as long as it is capable of holding the vehicle 40 at a predefined distance from the elongated profile 31 in any orientation of the elongated profile 31.

Hereafter a second rail profile 31, in particular a tubular profile with a circular cross-section, and a corresponding vehicle 40 will be described, with reference to FIGS. 22 and 23.

FIG. 22 shows a schematic cross-sectional drawing of an example of a tubular rail profile 31 with a circular cross section, and an embodiment of a vehicle 40 mounted thereto. What is said for FIG. 19 is also applicable here, except that the shape and dimensions of the housing, and the position of the wheels 45, 46, 47 is different for this vehicle 40. The functionality however is the same as that of the vehicle of FIG. 19.

FIG. 23 shows a variant of the vehicle of FIG. 22 mounted on a tubular rail profile 31 with a circular cross section in more detail. The main advantage of such a rail profile 31 is that it is relative easy to provide a rail track 30 of a relatively complex geometry, e.g. having a plurality of turns, such as shown e.g. in 7 and FIG. 24. This can be achieved relatively easy by combining curved and straight tubular track segments. Such tubular segments may be readily available, or can be easily produced by rolling. No torsion of the circular profile 31 is needed, contrary to a T-profile. A second advantage of the tubular profile with circular cross-section is that the vehicle 40 can easily change position with respect to, e.g. “around” the rail profile 31. This may e.g. be achieved by using a guiding rail 54 mounted to the tubular profile 31. In the embodiment shown in FIG. 23, two first wheels 46 are mounted on opposite sides of the guiding rail 54, for aligning the vehicle 40 to the position of the guiding rail 54. This effect can also be achieved in other ways, e.g. by using a guiding rail 54 with an external groove, the groove being adapted for receiving a protruding part of the vehicle 40, such as e.g. a pin. The guiding rail 54 is preferably hollow in order to be combined with an RFID location indicator 34.

FIG. 24 shows an example of a tubular profile 31 with a circular cross-section, whereto (segments of) the guiding rail 54 are positioned such that the vehicle 40 makes a turn of 180° around the tubular profile 31 when moving from a first plane α1 to a second plane α2. By doing so, it can be assured that the vehicle 40 is in a “hanging” position in both the lower plane α1 and the higher plane α2, which may be advantageous for scanning e.g. barcodes mounted only on top of pallets 21, or for detecting RFID-tags on pallets 21 from only above the pallets.

Referring back to FIG. 23, the vehicle 40 further may comprise a battery 44 for powering an electrical motor 49. The battery is preferably rechargeable. The rail system 30 may have at least one recharging station (not shown), e.g. located at an end position of the track 30. Alternatively or in combination with the battery, the rail profile 31 may have a pair of conductors 55 provided for supplying electrical power to the vehicle 40, via sliding contacts 56. Providing such conductors may be quite a challenge in curved portions of the rail profile, but is relatively easy in straight track portions. The need for such conductors 55 on curved portions may be omitted by providing a battery 44 with at least sufficient energy for moving from one straight track portion with power conductors to the next. Alternatively such conductors 55 may be omitted altogether, but then the battery capacity has to be sufficient for covering the entire track length. Such an arrangement may also be used at an end position of the rail, serving as a recharge station. The skilled person can find a trade-off between the number of power conductors along the track, and the capacity (thus size and weight) of the battery. Alternatively or in combination therewith, the vehicle may further have solar cells for recharging the battery 44 by converting light energy into electrical energy. Note that in case sliding contacts 56 are provided, the detected pallet information may also be communicated over the electrical conductors 55 via a modem, instead of over RF. Any existing technique for modem-communication over power lines may be used. This may require however a memory for storing the information between such communication positions. In the extreme case, the memory is provided for storing the complete information detected on the entire track 30, in which case no wireless communication or modem communication between the vehicle 40 and the computer system 90 is required. In still another alternative, powering and even data communication can optionally be performed in a contactless manner, e.g. using induction instead of using sliding contacts.

Referring back to FIG. 23, the vehicle 40 may further have a motor controller 52 for controlling the motor 49. The motor controller 52 may be capable of driving the motor, e.g. the electrical motor 49 at different speeds, and for reversing the motor. In an embodiment, the motor controller 52 may be adapted for controlling the motor speed depending on the amount of information detected and/or to be transmitted, e.g. as a function of the buffer filling of the RF-transmitter. The vehicle 40 may then e.g. decrease speed or stop when many items are detected and thus a lot of information is to be transmitted, and may increase its speed when less items are detected, and thus less information is to be transmitted. Preferably however the vehicle has first communication means 86, e.g. a Wifi-transmitter and one or more Wifi-antennas for transmitting the information to a computer system 90.

This body of the vehicle 40 shown in FIG. 23 has a cylindrical shape with a circular cross-section (apart from the opening above), but cylindrical shapes with a polygonal cross-section, e.g. hexagonal or octagonal cross-section may also be used. Such shapes may facilitate the positioning and orientation of e.g. RFID-antennas 84, or other parts, such as illumination means, e.g. a light source 82 for illuminating a pallet 21 to facilitate its detection using a barcode-reader 80, or to mount a digital camera 81 for taking pictures of the pallets 21 in the rack, or an obstacle detector 57, e.g. a laser or ultrasonic distance sensor for detecting obstacles, or contact sensors to detect collisions. If the rail system 30 forms a closed loop and the vehicle 40 is only configured to move “forward”, then the obstacle sensor is preferably located in the front of the locomotive 41. If however the vehicle 40 is adapted to move “forward” and “backwards”, then preferably also a second obstacle sensor is located at the end of the vehicle, e.g. on the last wagon 42. The camera may be used for taking pictures of each pallet 21, and sending that picture information also to the computer system 90. The pictures may be used e.g. to check the status of pallets, such as e.g. damage, leakage, etc.

As for its holding means 43, the vehicle 40 shown in FIG. 23 has six ball casters 96 (three of which are visible) for holding the vehicle close to the rail profile 31. As before, the first wheels 46 are movably, e.g. rotatably mounted, as indicated by the double arrow for providing a flexible but firm grip. The vehicle 40 further has a toothed wheel 47 for engaging with a toothed rack 37 optionally present on rail portions, for allowing the vehicle 40 to ascend or descend upright track portions. The toothed rack 37 is preferably flexible so that it can be positioned bended in a helicoidal shape around the profile. The toothed rack 37 may form part of the guiding rail 54, as shown. An example of a track with toothed rack portions is shown in FIG. 24, where toothed parts of the guiding rail 54 are indicated in full black. As can be seen, the toothed rack 37 is required in locations where the vehicle has to climb or descend.

FIG. 25 shows an example of the relative positions of the first wheel 46 and the toothed wheel 47 of a vehicle 40, with respect to a rail with and without a toothed rack, as illustrated on the right (B-B) and on the left (A-A) of FIG. 25 respectively. In the case without a toothed rack 37 (left), the first wheel 46 is in contact with the rail profile 31, for moving the vehicle 40. In the case with toothed rack 37 (right), the toothed wheel 47 is in contact with the toothed rack 37, and is provided for moving the first wheel 46 away from the track profile 31, by by “lifting” it, so that the first wheel 46 no longer makes contact with the rail profile 31. By choosing a smaller diameter for the toothed wheel 47 than for the first wheel 46, the vehicle speed can be decreased (when ascending or descending), and/or the torque increased (for the same motor speed). In an embodiment the ratio of the diameter of the toothed wheel 47 versus the diameter of the first wheel 46 is less than 100%, preferably less than 80%, more preferably less than 60%, e.g. about 50%. In embodiments, the dimensions of the toothed rack 37 and of the toothed wheel 47 and of the first wheel 46 are chosen for automatic disengagement of the first wheel 46 from the rail profile 31 at track locations where the toothed rack 37 is present, and for automatic engagement of the first wheel 46 to the rail profile 31 at track locations where the toothed rack 37 is absent. In this way active engagement/disengagement of the first and toothed wheel 47 can be avoided. In the embodiment shown in FIG. 25, such automatic (dis)engagement is achieved by providing the end portions of the toothed rack 37 with a ramp 58.

FIG. 26 shows an example of a possible configuration of the features of the vehicle 40, as discussed above, distributed over one locomotive 41 and two wagons 42. This is only one example, and other configurations are also possible. The vehicle of FIG. 26 has three carriages 41, 42a, 42b, each having holding means 43, and all being electrically and mechanically interconnected. Only the locomotive 41 has driving means, comprising a motor 49 and a motor controller 52 for driving at least a first wheel 46, a battery 44 for powering the motor, and optionally any or all of a barcode reader 80, a digital camera 81, and a light source 82. The first wagon 42a has first communication means 86, comprising a first RF transceiver 87, e.g. a Wifi-transceiver and a first RF antenna 88, e.g. a Wifi-antenna, and may have an additional battery 44b. The second wagon 42b has an RFID reader 83 and at least one RFID antenna 84 as detection means 43 for detection pallet information as well as RFID location indicators, and optionally one or more distance sensors 85, e.g. laser based or ultrasonic distance sensors for determining via another way (than by RFID) the presence of a pallet, and for estimating the distance between the vehicle 40 and the pallet 21. This makes the location information more reliable. Although the functions are represented here as individual blocks, in practice one or more features may be combined in a single integrated device.

A typical weight of a prototype vehicle 40 (anno 2012) is about 5.0 kg. The elongated profile 31 of the rail system rail system 30 is preferably made of a lightweight material having a mass density lower than 3000 kg/m³. The use of lightweight materials facilitates the handling of the rails during installation, and adds minimal weight to the pallet rack 20. A suitable material for the elongate profile 31 may be aluminum or an aluminum alloy, or a plastic material, such as e.g. PVC, but other materials may also be used.

The length of the vehicle may e.g. be about 3×17 cm=51 cm. It is an advantage to provide a vehicle 40 having more than one carriage, because the components can be placed further apart, so that interference between the different components may be reduced.

A particular application of the inventory monitoring system 1 described above, is an automatic inventory system, comprising a rail system 30, a vehicle 40 and a computer system 90, the vehicle 40 being movably mounted to the rail system, and having detection means 79 for detecting items in the pallet rack 20, and having first communications means 86 for communicating with a computer system 90, the computer system having second communication means 91 for receiving the detected information from the vehicle, and a database for storing that information.

A method is also provided for taking an inventory of items stored in a pallet rack 20 using such an automatic inventory system, the method comprising the steps of moving the vehicle 40 on the rail system 30 and detecting at least one item 21 in the pallet rack 20. Typically such a detection result may be transmitted, thus the method also may comprise transmitting the information detected to a computer system 90, e.g. using the first communication means 86, receiving the information in a computer system 90 using the second communication means 91 and e.g. storing the information in the database. Alternatively, instead of transmitting it, the information also may be stored locally and transferred when the vehicle is back into its base station or when a memory device of the vehicle is read-out, e.g. after mechanical engagement to a computer system of a base station. Such a method also can comprise other steps such as controlling a motor speed depending on the amount of information detected, detecting a location indicator (34) for identifying a location of the vehicle (40) on the rail system (30), powering the vehicle (40) through the rail system (30), etc. More generally, the method may comprise steps and correlated advantages corresponding with the functionality of the features described for the system according to other aspects in the present invention.

In some embodiments, the system advantageously is adapted for detecting an identification tag using one technique, such as e.g. RF-ID or barcode, while it furthermore also is adapted for performing a different detection technique, e.g. a distance measurement or a visual detection. Combining different measurement techniques may be advantageous e.g. to reduce false readings. The results for the different detection techniques may be correlated to each other in a processing system and optionally also be correlated with other detected properties, such as e.g. environmental properties measured near the item that is monitored. In this way the systems becomes even more thrust worthy.

In one aspect, the present invention also relates to a kit of parts, comprising a rail system mountable to a construction for forming at least one track for guiding at least one vehicle, and at least one vehicle movably mountable to the rail system and being adapted for moving over the rail system. The rail system comprises a track extending at least in a horizontal and a vertical direction with respect to the construction, and wherein the vehicle is adapted for ascending and descending the track. The rail system and/or the vehicle may comprise one or more further features of the inventory monitoring system as described above. Such a kit of parts can be used for a plurality of applications, such as for example for guiding a camera to obtain images from different points of view and different heights or for determining environmental parameters such as temperatures at different heights in a certain space.

By way of illustration, embodiments of the present invention not being limited thereto, some optional features will be further discussed below. These features will be described with reference to particular embodiments, but can mutates mutandis be implemented in other embodiments described above, such implementation also being envisaged within the scope of the present invention.

In a first further illustration, the vehicle may comprise a controllable means for handling, e.g. picking up items, grasping items, holding items, . . . . Such a controllable means may be a moveable robot arm. The latter allows that a physical interaction with e.g. the items counted, handled, stored, . . . can be performed, e.g. based on the input of the sensed signals. In this way, something that is recognized by the sensing devices, can be grasped, picked up, . . . and transported, moved, . . . by the vehicle. Movement of the moveable arm may for example be based on or controlled by microcontrollers. The possibility of introducing a controllable means for handling may allows for application of the system in a partially or full automated pick up and/or reaching and/or placing machine, e.g. for selecting fruits that are ripe. An illustration of such a system is given in FIG. 27, whereby both a vehicle 202 and a robotic arm 204 attached thereto is shown.

In a second further illustration, the possibility of applying local buffering of the sensor input on a local database on a small computer, e.g. on a creditcard size computer is discussed in some more detail. Such local buffering can e.g. be performed prior to passing the data to a remote server. The latter has the advantage that no continuously stable connection is required with the database, but that measurement data can be transmitted the moment a trustworthy connection with an external database can be established. The small computer may have the possibility to provide a webserver functionality, including a database functionality and a 3G router. An effect of using a local database on a small computer is that large quantities of data that may be crucial can first be buffered in a safe way and can thereafter, either continuously or on regular moments in time, be transmitted. In such an embodiment, although no permanent connection is required between the vehicle and the not-local server on a remote location, information still can be measured and/or captured and/or stored continuously.

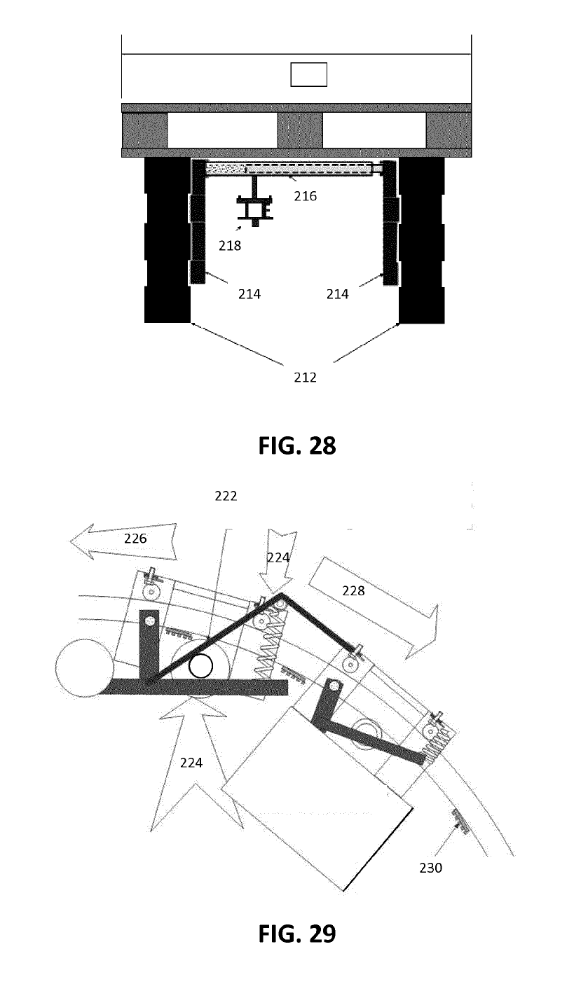

In a third example, an alternative manner for fixing the tracks on which the vehicle is moving to the construction elements, e.g. to a pallet rack, is described. The tracks may comprise or may be connectable to clamping means that can be clamped between the construction elements. One example of such clamping means may be a set of telescopic hollow tubes, rods or profiles, whereby an internally mounted spring provides a tension so that the telescopic hollow tube, rod or profile construction extends to a maximum possible length between the construction elements. Adapters, e.g. plastic adapters, can be provided between the clamping means and the construction elements, to compensate for irregular shapes and profiles of the construction elements. In one example, such adapters may have a flat surface which typically will be directed towards the clamping system and will have another modified surface with a complementary shape or profile, substantially complementary to the construction elements shape or profile for making contact with the construction elements. The adapters could e.g. be fixed to the construction elements with adhesive tape, although any other type of fixation also can be used. By way of illustration an example thereof, embodiments of the present invention not being limited thereto, is shown in FIG. 28, showing the horizontal beams 212 of the pallet rack, the specific adapters 214 for adapting to vendor specific beams which may be attached with adhesive tape, a light weight mounting system 216 comprising a light weight rod in a hollow rod which can be spanned using a springsystem between the adapters and a rail 218 that can be attached to the mounting system. Such a fixation elements have the advantage that they allow to compensate for horizontal movements of the beams when e.g. pallets are positioned or removed. Another advantage of such embodiments is that the pallets can freely be moved over the beams and that there is no risk of destruction of the tracks as these are fully positioned in the none used area of the beams.

In a fourth example, a system comprising a plurality of vehicles is described, whereby at least one driven vehicle, e.g. motorized vehicle, is present, typically referred to as locomotive, and at least one vehicle is not driven, typically referred to as wagon, but pulled by the locomotive. The features of the present example are especially advantageous for hanging vehicles, i.e. vehicles that have their wheels or chains running on the track on the upper side and where a substantial part of the mass of the vehicles is positioned below these wheels or chains. The fourth example illustrates an advantageous way of connecting the wagon to the locomotive. One or more flexible connection means can be provided that are fixed in a particular way to the wagon and the locomotive. The flexible connection means can be any type of flexible connections means, such as for example flexible wire, flexible rope, chains, etc. One particular example may be a strong polyamide wire. The flexible connection means is connected at a lower front side of the locomotive, at an upper side of the wagon and is in between these connection points guided over an upper point at the back side of the locomotive. In this way, when the vehicle is rising, the weight of the wagon will provide an additional pressure on the wheels or gear of the locomotive pressing the wheels or gear onto the guiding track, e.g. pressing the gear on the toothed track. This additional pressure is caused by the gravity of the wagon that is pulled. In FIG. 29, a particular way of implementing this is illustrated, whereby at both left and righthand side of the locomotive and the wagon such a connection is provided. The flexible means 222, e.g. towing cables for linking the locomotive with the wagons typically present at both sides of the body) thereby is fixed to the drive carriage allowing to drive the wheels or gears of the locomotive. The flexible means can e.g. be connected to the inflection point of the construction. A pressure is induced as indicated by arrows 224. Arrow 226 indicates the driving direction and arrow 228 illustrates the towing force, which is due to the weight of the pulled wagon.

An additional advantage of the connection means between locomotive and wagon that is obtained is that it allows turning in X, Y and Z direction while keeping locomotive and wagon connected. In FIG. 29, a part of the toothed rack 230 also is shown.

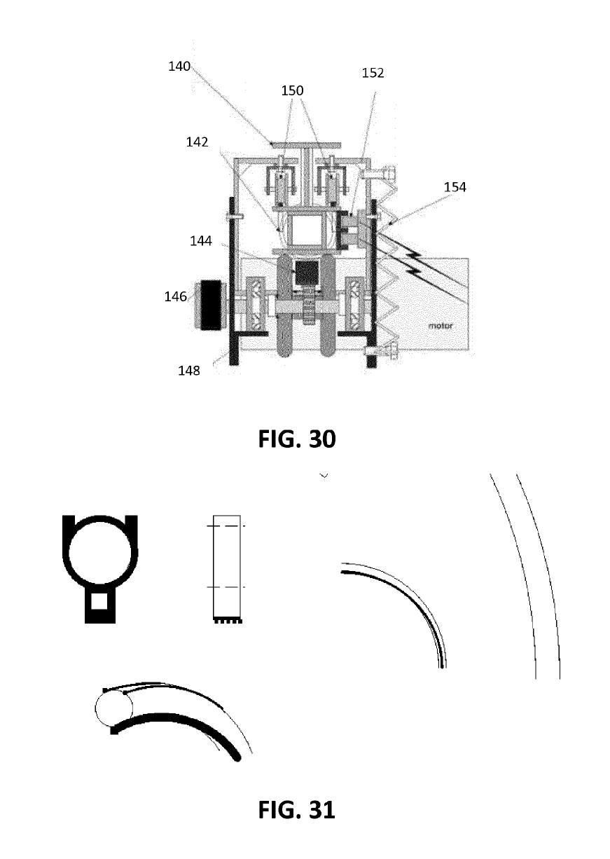

In a fifth particular example, a particular configuration for the tracks used for guiding the vehicle is described. The profile used for the tracks may in one embodiment have a first shape for horizontally or vertically oriented tracks and may have a second, different shape, for tracks that have a vertically curved path. In the example shown, embodiments not limited thereto, positions where the tracks follow a horizontal path and/or horizontal turn, the profile used may be based on an I or T shaped profile. The same is valid for portions of the track that follow a vertical path. Nevertheless, for portions where the track follows a curved vertical path, such as for example a helicoidal path, the track is not based on an I or T shaped profile but on a hollow tube. On the hollow tube one or more guiding rails are present and these may follow a helicoidal path. Both on the I or T shaped profile and on the hollow tube profile, a rectangular or square shaped profiled may be added at the bottom side, as illustrated. When a switch is made between different types of paths, the shape of the tracks used, i.e. the profile on which they are based, changes and a switch between the I or T shaped profile and the hollow tube shaped profile is used. The different tracks are shown in FIG. 30 and FIG. 31. In FIG. 30 an I or T shaped profile 140 is shown which is combined with a rectangular tube with tread for rubber tires. Furthermore, a hollow tube 142 is shown in the background, whereby the rails are mounted or are integrated in the design of the horizontal profiles and in the tube profile. This allows in an almost seamless continuation of the rails on the T profile to the rails on the hollow tube. Further shown are a bottom guiderail 144, which rail is toothed when the track is climbing or descending. Furthermore position tags may be mounted to this guiderail. Also shown is an endless toothed belt 146, allowing transmission of the power from the motor to rubber wheels. At the bottom of the drawing, the pivoting sled 148 is shown. This sled pivots on the front “body holder” and is pulled towards the thread e.g. with an extension spring that is fixed to the rear “body holder”. The free pivoting wheels 150, e.g. metal wheels, for guiding on the rail are also shown. The sliding contact 152 for electrical power transmission from the electric rail to the locomotive is also shown. Furthermore, also the extension spring 154 pulling the pivoting sled (on which the rubber wheels are mounted) against the (horizontal) tread or against the bottom of the hollow tube, when the track curves, is shown.

In FIG. 31, at the top left corner a front view of the hollow tube is shown whereas at the top right corner a side view of the hollow tube is shown. At the bottom, a three dimensional view is shown of the hollow tube with a helicoidal rail.

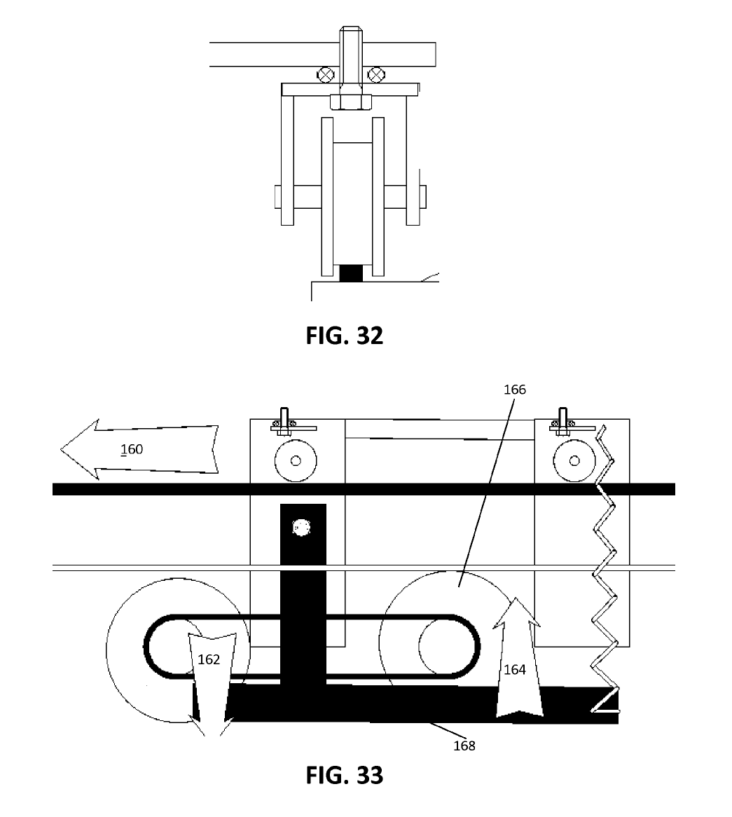

In a sixth particular example, a vehicle is described wherein the wheels used for moving on the track are based on layered hollow wheels that can rotate around their decentralized vertical axis. In the present example, the wheels move on the metal or plastic rails. In one embodiment, the wheels can run so that the rails are in spaces in the wheels. An example of a wheel that can be used is shown in FIG. 32 and FIG. 33. The vertical axis, by which the wheels can be turned left or right, are positioned outside the center of the wheel. The weight of the vehicle is carried by a bodyframe comprising two square shaped carriers that are interconnected by profiles. The wheels are positioned perpendicular to the plane of the rails. In FIG. 33, the driving direction is indicated with arrow 160, the motor weight is indicated with arrow 162 and the pressure is indicated with arrow 164. Furthermore, the rubber wheels 166 and the pivoting sled 168 also is indicated.

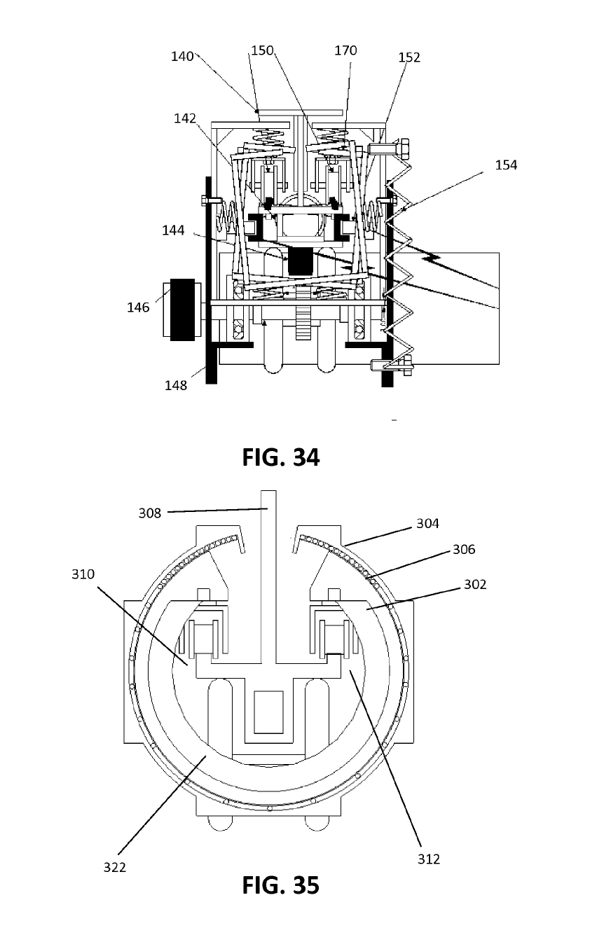

In a seventh particular example, a particular configuration for the suspension of the vehicle's body and (upper) wheels to the rails of helicoidal tracks is described. The configuration shown is based on a frame in frame concept, whereby one frame is positioned in a second frame, and moveably or flexibly connected, e.g. via springs such as 6 springs, with the walls of the second frame. In the present example, the first frame can only move “in one plane” within the second frame. (up and down and left and right but not forward and backward). The flexibility of the first frame allows that the vehicles—the wheels thereof being positioned by/on the first frame—can perform the torsion movement that is induced by the helicoidal track. An example of such a configuration is shown in FIG. 34. The latter allows that if the vehicle has wheels at different positions these can take a different angle with respect to the rails. FIG. 34 shows, besides the components already discussed in FIG. 30, furthermore a spring suspended sub-frame 170 with the metal wheels. The subframe—also referred to as an inner frame—thereby is suspended in the main frame.

In an eighth particular example, another particular configuration for the suspension of the vehicle's body and (upper) wheels to the rails of helicoidal tracks is described, being an alternative for the system described in the 7^{th} example.

It is an advantage of embodiments of the present invention that a configuration as described above can be used for allowing the vehicle to rotate around the axis of the rail. In the present embodiment, this is achieved by configuring the system as a frame in frame concept, whereby the inner frame is arranged rotatably in the outer frame. The rotating frame thus fits in the static frame. In some embodiments, roller bearings may be provided in the static or the rotating frame, in order to improve the movement between the two frames. This concept is similar as the one shown in example 7, but instead of using a spring for positioning both frames with respect to each other, in the present example a complementary shape is used for positioning both frames with respect to each other, rendering the frames rotatable with respect to each other, rather than only moveable. The frame in frame concept also assists the system in easily allowing a vehicle to follow a turn in a rail in a plane.

FIG. 35 illustrates a front view of the frame-in-frame construction, wherein the rotating frame 302, the static frame 304 and roller bearings 306 can be seen. The rail 308 along which the movement of the vehicle will occur, is also indicated. Along the rail 308, the vehicle can move, making use of hollow wheels 310, 312, whereby in the present example two wheels are shown, one wheel on a profile at a left side of the rail and one wheel on a profile at the right side of the rail. These guiding wheels 310, 312 thus ride over the rail track. The wheels are configured such that they can rotate horizontally. Also indicated in the drawing are the driving wheel 322. These wheels are driven by a transmission system operated by a motor and cause the movement of the vehicle. These wheels furthermore provide a counter force on the rail. The rail thus is clamped between the guiding wheels 310, 312 and the driving wheel 322. The driving wheel is configured for keeping the guiding wheels of the vehicles against or close to the rail, even when it runs over a curved or torsed rail. Typically, this may be performed using a system that can provide a variable force, e.g. using a spring.

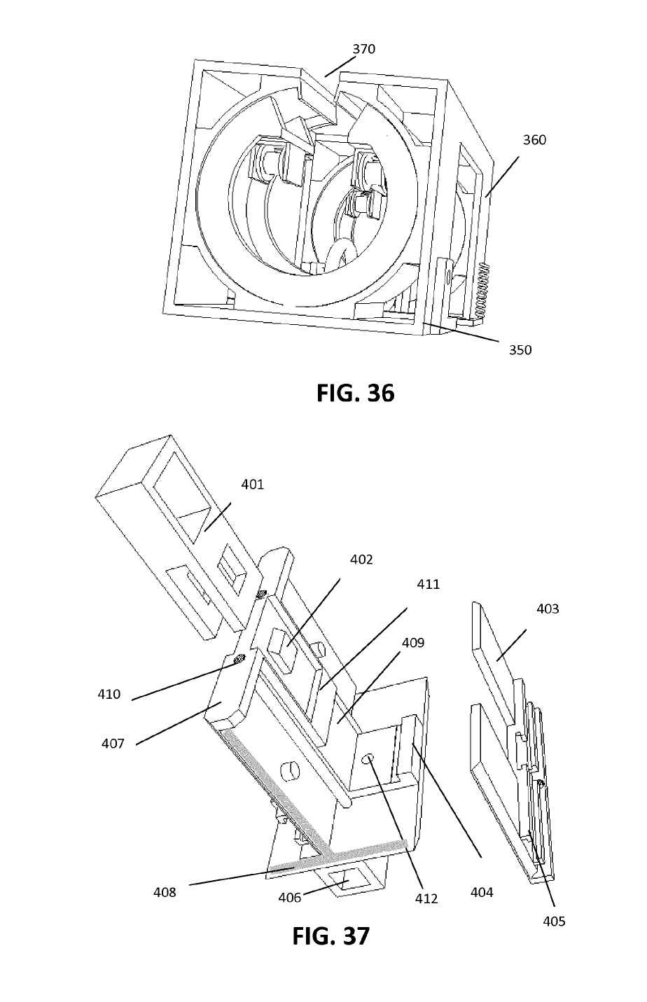

For balancing reasons, typically a double arrangement as shown in FIG. 36 is provided, one closer to the front of the vehicle and one closer to the back of the vehicle. An example of a system wherein two arrangements are provided and to which the remainder part of the vehicle can be connected is shown in FIG. 36. In the present example, the two arrangements 350, 360 are connected to each other, as the static frames of both arrangements are made of a single piece. The latter may assist in providing the necessary strength. In FIG. 36, furthermore an opening 370 at the top side of the frame can be seen which allows mounting of the system on the rail on which the vehicle will move. When mounted, the system is suspending on the rail, whereby the rail is supporting the guiding wheels.

Embodiments according to the above described system allow to deal in a robust manner with curving of the rail in all directions.

In a further related aspect, the present invention also relates to a connector for connecting guiding rails, e.g. for an inventory system as described in the present invention. The connector according to embodiments of the present invention provides the advantage that it allows fast and easy connection between two T-shaped profiles can be obtained. Furthermore, the connectors can be easily fixed to a mounting surface, thus allowing fast connection of the rail system to a mounting surface or surrounding.

According to embodiments of the present invention, the connector can be made of plastic material or any other suitable material. One way of manufacturing such pieces may be injection molding, although embodiments of the present invention are not limited thereto and can also be made using any other suitable technique such as for example extrusion, casting, etc.

The connector according to embodiments of the present invention comprises a mounting means for mounting the connector to a mounting surface. Such a mounting means may be a clipping means, a clicking means, may have a portion suitable for glueing, for nailing, for screwing, or may be fixable to the mounting surface in any other suitable way. The mounting means 401 of the connector is shown in FIG. 37.

The connector may have any suitable width, such as for example between 1 cm and 10 cm, e.g. between 3 cm and 8 cm, e.g. about 5 cm. The connector may have any suitable height such as for example between 1 cm and 10 cm, e.g. between 4 cm and 9 cm, e.g. about 6 cm. The thickness of the connector advantageously is selected such that it is not too high in order for the vehicle to be able to pass over the connector. In one example, the thickness of the connector may be between 6 and 10 mm.

In one embodiment, the connector may be designed such that the current and power cables can be connected to points of contacts, e.g. for powering sliding contacts in the rail system. An electrical contact means may therefore be present in the connector.

By way of illustration, embodiments of the present invention not being limited thereto, a particular example of a connector is described, illustrating standard and optional features according to embodiments of the present invention.

In the particular example of FIG. 37, a mounting means 401 is shown for fixing the connector to a mounting surface. In the present case, the mounting means 401 is e.g. suitable for being fixed to a bar having a square cross-section. The mounting means 401 could be integrally made with the connector. Nevertheless, in some embodiments, the mounting means may be releasable connectable to the connector, which may assist in more ease of manipulating. In such cases, the mounting means 401 may be provided with a fixation means for fixating the mounting means 401 to the connector. In the present example, the fixation means is a protruding portion 402 on the connector that fits, e.g. by clicking into an opening made in the mounting means 401.

The connector of the present example also comprises a closing portion 403 (drawn separately in FIG. 37) which can be positioned on, e.g. clicked in, the connector body 7, when both rail ends are positioned correctly for closing the connector. In FIG. 37, also a small portion 404 of the rails is shown, which rails are to be connected using the connector. When the closing portion 403 is mounted, the connector has a T-shaped sleeve wherein the T-shaped profiles fit. Furthermore, accurate positioning of the rail profiles may be obtained by additional positioning means for the rails. The connector furthermore may for example comprise a rail fixing feature 411, e.g. a protrusion, that is adapted for cooperating with a rail fixing feature present in the rail. The rail fixing features may e.g. be a protrusion in the connector and a whole in the rail or vice versa. By cooperation of the rail fixing features on the connector and the rail, a correct positioning of the rail can be obtained.

In embodiments where electrical or data contacts are provided, the connector furthermore typically comprises an electrical guideway 405 for guiding the electrical connections which can be contacted e.g. by the gluiding contacts.

Further in the drawing, also a hollow portion being part of the rail can be seen. This hollow portion, i.e. a hollow tube running at one side of the rail, may be used for guiding wiring. Furthermore, depending on the specific application, the hollow tube also may be used for mounting the toothed belt—e.g. at portions where the rail is used for bridging height or portion close thereto. The hollow tube may be discontinuous along the track, for providing a region where wires can be easily connected. An additional, removable cap may be provided to provide access to those regions, but allowing to close them when the system is in use. Different feedthroughs for the wires may be provided, so that electrical connection can be made in the connector. These feedthroughs 412 are also indicated.

The powering of the system may be performed at positions where connectors will be preset, and the connector therefore is provided with feedthroughs 410 for feeding current, data or powering cables through the connector towards the rails, e.g. the hollow portion provided at one side of the rail.

The electrical connection means may comprise an electrically guiding element, such as a copper plate. The connector therefore may comprise an electrically guiding element holder 408 wherein the electrically guiding element can be positioned. The electrical feedthroughs 410 typically are positioned such that electrical connection with the electrically guiding element can easily be made. The electrically guiding element, when positioned in the holder, can be such that it is pressed against the electrical guide so that the sliding contact—that is contacting the electrical guide in the rails—can pass over the electrically guiding element at the moment the sliding contact passes the connector. Typically an electrically guiding element holder may be provided at each side of the connector.

The connector may be provided with slanted surfaces where appropriate, e.g. for reducing the pressure of the vehicle on the rails and the connector when a vehicle is passing the connector.

The present invention also relates to the use of a connector for connecting rails to each other, e.g. rails of an inventory system as described above.

### REFERENCE NUMBERS

1 inventory system

10 forklift

11 forks

20 pallet-rack

21 pallet

22 upright post

23 corner posts

24 beam

α substantially horizontal plane defined by beams

γ vertical plane defined by beams located on top of each other

π substantially vertical plane defined by substantially vertical posts

β substantially vertical plane formed between posts and/or beams located on top of each other.

30 rail-system

31 elongated profile

31x curved portion of the elongated profile

32 individual tracks, e.g. 2D-track

33 single three-dimensional track

34 location indicator

35 switch

36 suspending bars (or support)

37 toothed rack

40 vehicle

41 locomotive

42 wagon

43 holding means

44 battery

45 freely rotatable wheels

45s freely rotatable side wheels

46 first wheel

47 toothed wheel

48 location indicator holder

49 motor

50 arm

51 transmission means

52 motor controller

54 guiding rail

55 power conductors

56 sliding contacts

57 obstacle detector

58 ramp

e1 first end position

e2 second end position

79 detection means

80 barcode reader

81 digital camera

82 light source

83 RFID-reader

84 RFID-antenna

85 distance sensor

86 first communication means

87 first RF (e.g. Wifi) transmitter or transceiver

88 first RF (e.g. Wifi) antenna

90 computer system

91 second communication means

92 second RF (e.g. Wifi) receiver or transceiver

93 second RF (e.g. Wifi) antenna

94 database

95 stacked row, bay

96 ball casters

97 control unit

1-59. (canceled)

60. A kit of parts comprising a rail system mountable to a construction, the rail system forming at least one track for guiding at least one vehicle, and the kit of parts comprising at least one vehicle movably mountable to the rail system and being configurable for moving over the rail system,
wherein the rail system comprises a track extending at least in a horizontal and a vertical direction with respect to the construction, and wherein the vehicle is adapted for ascending and descending the track.

61. A kit of parts according to claim 60, wherein the rail system comprises a track following a curved vertical path, wherein the track has the profile of a hollow tube.

62. A kit of parts according to claim 60, wherein the track follows a helicoidal path.

63. The kit of parts according to claim 60, wherein the at least one track comprises an elongated profile being a tubular profile having a substantially rectangular, circular or hexagonal cross-section, or comprises an elongated profile having a T-shape or I-shape cross-section.

64. A kit of parts according to claim 60, wherein the vehicle is provided with a holding means for suspending the vehicle to the at least one track, the holding means comprising a first frame moveably and flexibly connected in a second frame.

65. A kit of parts according to claim 64, wherein the first frame is flexibly connected with the walls of the second frame.

66. A kit of parts according to claim 63, wherein the first frame is rotatably arranged in the second frame.

67. The kit of parts according to claim 60, wherein the rail system comprises at least one switch for switching between tracks portions.

68. The kit of parts according to claim 60, wherein the rail system comprises at least two conductors for providing electrical power to the vehicle, and wherein the vehicle has sliding contacts for connecting to the conductors.

69. The kit of parts according to claim 60, wherein the at least one track comprises an elongated profile, and wherein the vehicle comprises holding means for movably mounting the vehicle to the elongated profile.

70. A kit of parts according to claim 69, wherein the holding means is adapted for holding the vehicle at a predefined distance from the elongated profile, in any orientation of the elongated profile.

71. A kit of parts according to claim 69, wherein the holding means comprises one or more of a plurality of freely-rotatable wheels mounted on opposite sides of the elongated profile and a plurality of ball casters.

72. A kit of parts according to claim 69, wherein the holding means is mounted on opposite sides of the elongated profile, and whereby the material of the holding means and the material of the elongated profile have a static friction coefficient smaller than 0.20.

73. A kit of parts according to claim 69, wherein the vehicle further comprises a first wheel drivable by a motor and mounted to the elongated profile for moving the vehicle along the elongated profile, the first wheel being movable with respect to the holding means for guaranteeing contact with the elongated profile also when the profile is curved.

74. A kit of parts according to claim 73, wherein the elongated profile further comprises over at least part of its length a toothed rack, and whereby the vehicle further comprises a toothed wheel arranged for engaging with the toothed rack, the toothed wheel being drivable by a motor.

75. A kit of parts according to claim 74, whereby the ratio of the diameter of the toothed wheel versus the diameter of the first wheel is less than 100%.

76. A kit of parts according to claim 74, whereby dimensions of the toothed rack and of the toothed wheel and of the first wheel are chosen for automatic disengagement of the first wheel from the rail profile at track locations where the toothed rack is present, and for automatic engagement of the first wheel to the rail profile at track locations where the toothed rack is absent.

77. A kit of parts according to claim 74, whereby end portions of the toothed rack show a ramp.

78. A kit of parts according to claim 60, wherein the rail system comprises at least two conductors, and wherein the first and second communication means each comprise a modem for communication over the two conductors.

79. A kit of parts according to claim 60, wherein the vehicle comprises detection means for detecting information of pallets which are located in the vicinity of the rail system in an inventory monitoring system.
